(19) United States
(12) Patent Application Publication
(10) Pub. No.: US 2004/0078287 A1
(43) Pub. Date: Apr. 22, 2004

(54) Method and apparatus on stock price list and profit calculation in cyber stock trading system

(76) Inventor: Yong-Cheol Yang, Seoul (KR)

Correspondence Address: Blakely Sokoloff, Taylor & Zafman, 7th Floor, 12400 Wilshire Boulevard, Los Angeles, CA, 90025, US

(21) Appl. No.: 10/451,946

(22) PCT Filed: Dec. 18, 2001
(86) PCT No.: PCT/KR01/02200

(30) Foreign Application Priority Data
Dec. 26, 2000 (KR) 2000/82386
Mar. 2, 2001 (KR) 2001/10953
Mar. 26, 2001 (KR) 2001/15814

(51) Int. Cl. G06F 17/60

(52) U.S. Cl. 705/26

(57) ABSTRACT

Disclosed are a cyber trading service apparatus and method. A CPU displays a sell order screen when a user logs into a cyber trading system. The CPU receives stock price information on a holding item from a securities server and displays the information on a quotation information window when the user selects a holding item button on the sell order screen. The CPU calculates a stock price and a profit and loss list corresponding to the stock price, and displays them on a profit and loss list window when the user selects the profit and loss item of the profit and loss list. A profit and loss analysis value is displayed using the selected stock price as a sell price when the user selects a specific quotation on the profit and loss list window. A sell order is transmitted to the securities server when an order transmission button is selected.

### BACKGROUND OF THE INVENTION

(a) Field of the Invention

The present invention relates to a cyber trading service apparatus and method with a profit and loss analysis function. More specifically, the present invention relates to a cyber trading service apparatus and method with a profit and loss analysis function for letting an investor automatically know various calculation results without performing any form of calculation in each process of a trading cycle, and letting a user conveniently input a sell order.

(b) Description of the Related Art

In general, cyber trading on-line has significantly increased in securities exchanges. In Korea, day trading, where an investor buys and sells stocks over a very short term, exceeds 80% of stock movement. It is expected that cyber trading will gradually increase in foreign countries.

Cyber trading has increased due to greater access through personal computers (PCs), which facilitate provision of various stock information, a real-time grasp of market conditions, and fast trading orders. Also, trading frequency is significantly increasing due to alignment of worldwide securities quotations, increases in day trading, and convenience of trading orders.

The stock-trading cycle is one of stock price analysis→buy order→profit and loss analysis→sell order. When an investor increases the number of stock trades they do, they must frequently circulate through the trading cycle. The investor must analyze stock prices and profit and loss in each cycle, and frequently input trading orders.

However, in spite of the above changes in the stock environment, a conventional cyber trading system provides little information to the investor in the respective steps of stock price analysis, profit and loss analysis, and the sell order. Therefore, the investor must do mental arithmetic every day and perform the trading order accordingly. That is, the investor calculates the stock prices and the profit and loss by hand in each trading cycle, and performs the trading order by hand as well. As a result, it takes a long time to calculate the stock prices and the profit and loss. The investor gets tired, and there can be errors in calculation. Accordingly, rapidity is not guaranteed during cyber trading.

FIG. 31 shows an example of a profit and loss calculation performed by investors by hand or by mental arithmetic. Investors calculate or do mental arithmetic of profit and loss several hundred thousand through several million times every day. The investors therefore consume a large amount of energy and spend a huge amount of time.

Conventional problems in the respective steps in the cycle of stock price analysis, profit and loss analysis, and sell orders of stock trading will now be described.

1) Stock price analysis step—Prices the investor wishes to know are not provided. The conventional cyber trading shows only three (1.5%) stock prices during simultaneous bids and offers and only twelve (6.5%) stock prices during opening. Also, advance-decline ratios (ADRs) and advance-decline ranges are not provided during the simultaneous bids and offers. Each of the ADR and the advance-decline range based on the current price is provided during the opening.

2) Profit and loss analysis step—Profit and loss analysis information is not provided at the price where the investor wishes to know the profit and loss analysis information. Conventional cyber trading provides less than 0.4% of the entire profit and loss data, and the investor directly analyzes the profit and loss corresponding to the more than 99% remaining.

3) Sell order step—The investor inputs the sell price and the number of sell of the sell order by hand using a mouse and a keyboard, which is prone to error and is inconvenient. The sell price and the number of sell are often inversely input. Wrong numbers are often input. Several tens of eye movements and hand movements must be performed using the mouse and the keyboard. More than 10 seconds of time is spent on inputting the sell price and the number of stocks sell. After an input, the investor must check whether the input is correct. The investor cannot know the profit and loss that will be generated by the input value. Economic and mental losses are caused by the input of several million orders every day. In addition, the same input method is used for correcting orders and canceling orders.

4) Current price screen—There is no profit and loss information on the current price screen, which the investor looks at most frequently. The current price screen holds the core information on making trading decisions because the number of sell and buy of each quotation is displayed on the quotation window of the current price screen. However, the stock price information and the profit and loss information are dispersed because the profit and loss analysis of each quotation is not provided.

5) Only a result value at one price can be calculated at one time in conventional stock price and profit and loss analysis. When the price changes, the result value must be calculated again from the beginning. The investor cannot analyze the tendency of the profit and loss by hand because several hours are spent calculating result values with respect to several hundred stock prices.

6) A change in the profit and loss with respect to each price cannot be synthetically determined when calculating the profit and loss at one price at one time. The tendency of the entire profit and loss cannot be grasped by examining only one or two cells among several thousand cells.

7) Only one-dimensional calculation of a line can be performed in the entire area of the stock prices and the profit and loss: two-dimensional calculation cannot be performed. The calculation is performed by hand using an electronic calculator, the mouse, and the keyboard.

8) It takes a long time to inquire about account information. When an account information inquiry command is executed, the profit and loss is generally calculated by a server of a securities company. Therefore, it takes a long time and the investor must visit the securities company site every time. Accordingly, it is difficult to repeatedly inquire about account information.

### SUMMARY OF THE INVENTION

It is an object of the present invention to provide a cyber trading service apparatus and method having a profit and loss analysis function, which is capable of executing a cycle of stock price analysis, profit and loss analysis, and a sell order in between one and three seconds, according to the selection of an investor.

In one aspect of the present invention, there is provided a cyber trading service apparatus for providing a cyber trading service according to requests of a plurality of client PCs, the cyber trading service apparatus comprising: a main controller for calculating a profit and loss list and outputting operation result data when an operation request signal with respect to a profit and loss list is received from a corresponding client PC; and a profit and loss list operator for calculating the profit and loss list from the basic price, the number of holdings, the buy unit price, and the commission ratio of a corresponding item and outputting the operation result to the corresponding client PC when the account number, the item code, and the profit and loss item code of a user are input through the main controller.

In another aspect of the present invention, there is provided a cyber trading service apparatus for receiving securities information from the server of a securities company and providing a cyber trading service, the cyber trading service apparatus comprising a profit and loss analysis program storage unit for calculating a profit and loss list of each stock price with respect to a sell stock price to a buy stock price from the basic price, the number of holdings, the buy unit price, and the commission ratio of the corresponding item, a main memory for temporarily storing data, a central processing unit (CPU) for loading a corresponding program of the profit and loss analysis program storage unit in the main memory, executing the corresponding program, and outputting an operation result with respect to a profit and loss list when an operation request signal with respect to the profit and loss list is input from a user, and a display for displaying the operation result output through the CPU to the user.

In another aspect of the present invention, there is provided a cyber trading service method providing a cyber trading service according to requests of a plurality of client PCs, the cyber trading service method comprising the steps of transmitting current price information when a user accesses a cyber trading system of a client PC and selects a sell order screen, and receiving the account number, the item code, and the profit and loss item code of the user from the client PC, inputting the basic price, the number of holdings, the buy unit price, and the commission ratio of a corresponding item to a previously set operation program, calculating a profit and loss list, and outputting the operation result to a corresponding client PC.

In another aspect of the present invention, there is provided a cyber trading service method receiving securities information from the server of a securities company and providing a cyber trading service, the cyber trading service comprising the steps of a CPU displaying a main screen when a user logs into a cyber trading system of a client PC, the CPU receiving stock price information on a holding item from the securities server and displaying the stock price information on a quotation information window when the user selects a holding item screen on the main screen, the CPU calculating a stock price and a profit and loss list corresponding to the stock price using a corresponding operation program and displaying the stock price and the profit and loss list on a profit and loss list window when the user selects the profit and loss item of the profit and loss list by a drop-down button, and displaying a profit and loss analysis value using the selected stock price as a sell price when the user selects a specific quotation on the profit and loss list window and transmitting a sell order to the securities server when an order transmission button is selected.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a structure of a cyber trading service apparatus according to a first embodiment of the present invention;

FIG. 2 shows a structure of a profit and loss analysis system in the cyber trading system according to the first embodiment of the present invention;

FIG. 3 shows a detailed structure of a profit and loss list operation program database (DB) of the profit and loss analysis system according to the first embodiment of the present invention;

FIG. 4 shows a structure of a cyber trading system in a client personal computer (PC) in a cyber trading service apparatus according to an embodiment of the present invention;

FIG. 5 shows a sell order screen of the cyber trading system in the client PC in the first embodiment of the present invention;

FIGS. 6A through 6G are flowcharts showing the operations of the cyber trading service method according to the embodiment of the present invention;

FIG. 7 shows a stock price list operation routine;

FIG. 8 shows an advance-decline ratio (ADR) list operation routine;

FIG. 9 shows an advance-decline range list operation routine;

FIG. 10 shows a profit and loss range list operation routine;

FIG. 11 shows a yield list operation routine;

FIG. 12 shows a total sell amount of money list operation routine;

FIG. 13 shows a total sell ratio list operation routine;

FIG. 14 shows a total profit and loss list operation routine;

FIG. 15 shows a commission list operation routine;

FIG. 16 shows a commission ratio list operation routine;

FIG. 17 shows a net profit and loss list operation routine;

FIG. 18 shows a net profit and loss ratio list operation routine;

FIGS. 19A and 19B show the entire profit and loss list operation routine;

FIG. 20 shows a structure of a cyber trading service apparatus according to a second embodiment of the present invention;

FIG. 21 is a block diagram of the cyber trading system in the client PC according to a second embodiment of the present invention;

FIG. 22 shows the profit and loss analysis program storage unit of FIG. 21 in detail;

FIG. 23 is a flowchart showing the operation of a cyber trading service apparatus according to the second embodiment of the present invention;

FIGS. 24A through 24H show an example of the entire profit and loss list calculated by the cyber trading system;

FIGS. 25A and 25B show a sell order screen according to the present invention, on which account information, quotation information, and profit and loss information are intensively displayed;

FIG. 26 shows an example of a drop-down button and a profit and loss list by quotation window that are attached to a current price screen;

FIG. 27 shows an example of a profit and loss item list window displayed as the drop-down button is selected;

FIG. 28 shows arranged input variables and operation formulas of profit and loss analysis programs;

FIG. 29 allows comparison between a conventional sell order method and an improved sell order method according to the present invention;

FIG. 30 allows comparison between a conventional cyber trading method and a profit and loss analysis system according to the present invention; and

FIG. 31 shows an example of profit and loss calculations with respect to various profit and loss items, which are performed by an investor by hand and mental arithmetic.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

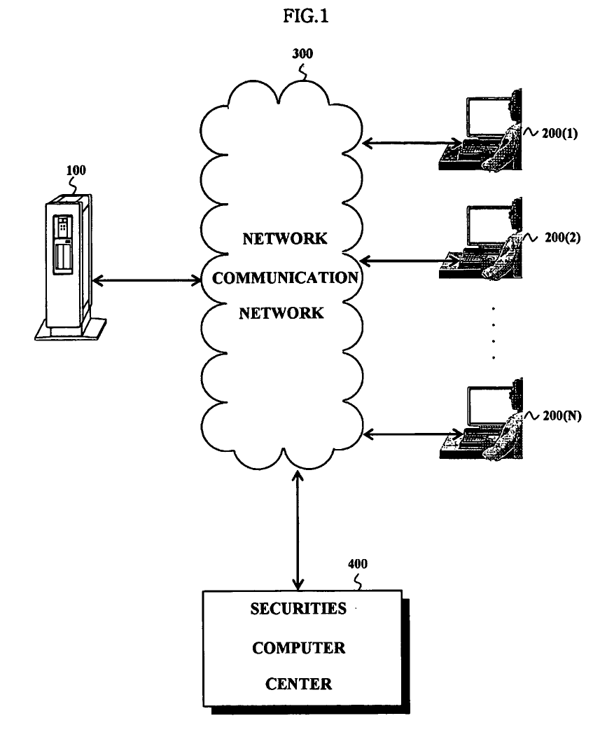

FIG. 1 is a block diagram of a structure of a cyber trading service apparatus according to a first embodiment of the present invention.

As shown in FIG. 1, the cyber trading service apparatus according to the first embodiment of the present invention includes a plurality of client personal computers (PC) 200(1), . . . and 200(N), a network communication network 300, and a profit and loss analysis system 100.

An exclusive emulator or web browser, by which an investor can perform cyber trading through a means such as a network communication network 300 and a CD (compact disk) from a securities company, is installed in each of the plurality of client PCs 200(1), . . . and 200(N). When the exclusive emulator or web browser is executed, the plurality of client PCs 200(1), . . . and 200(N) are connected to the profit and loss analysis system 100. When the respective users select a specific profit and loss item in a drop-down button in a sell order screen, an account number, an item code, and a profit and loss item code are output to the profit and loss analysis system 100 through the network communication network 300.

The plurality of client PCs 200(1), . . . and 200(N) receive a profit and loss list from the profit and loss analysis system 100 and display the profit and loss list on a sell order screen on the client PC 200. The network communication network 300 connects the plurality of client PCs 200(1), . . . and 200(N) to the profit and loss analysis system 100 of each securities company through a communication line so that data communications related to a profit and loss list are performed between the plurality of client PCs 200(1), . . . and 200(N) and the profit and loss analysis system 100. The profit and loss analysis system 100 inputs the basic price, the number of holdings, the buy unit price, and the commission ratio of a corresponding item to a previously set operation program; generates a profit and loss list, and outputs the operation result to the client PCs 200(1), . . . and 200(N) when the account number, the item code, and the profit and loss item code are input according to the drop-down button selection of the respective users on the sell order screens of the plurality of client PCs 200(1), . . . , and 200(N).

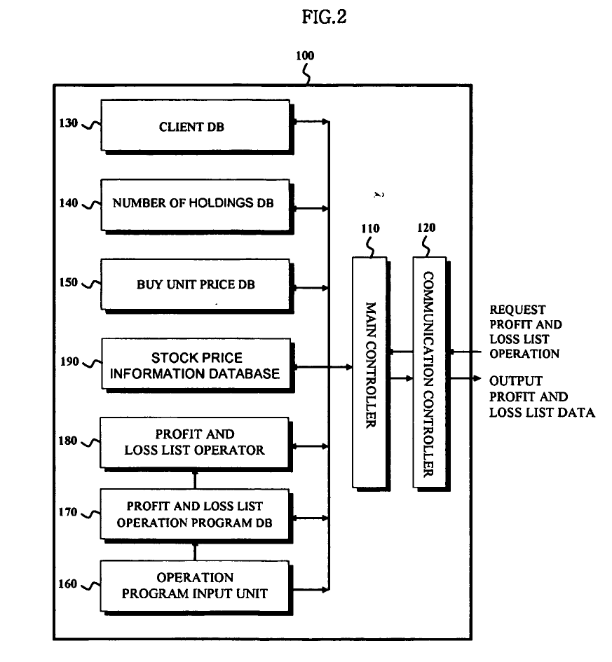

FIG. 2 shows a structure of the profit and loss analysis system in the cyber trading system according to the first embodiment of the present invention.

Referring to FIG. 2, the profit and loss analysis system 100 includes a main controller 110, a communication controller 120, a client database (DB) 130, a number of holdings DB 140, a buy unit price DB 150, an operation program input unit 160, a profit and loss list operation program DB 170, a profit and loss list operator 180, and a stock price information DB 190.

The communication controller 120 performs wire and wireless communications related to the profit and loss list between the plurality of client PCs 200(1), . . . and 200(N) and the profit and loss analysis system 100. The communication controller 120 receives data, transmits the received data to the main controller 110, and outputs the profit and loss list to the corresponding client PCs 200(1), . . . and 200(N) through the network communication network 300 according to the control of the main controller 110 when an operation performance key signal, the account number, the item code, and the profit and loss item code are input according to the drop-down button selection of each user. The main controller 110 determines whether the operation performance key signal, the account number, the item code, and the profit and loss item code in accordance with the drop-down button selection of the users of the client PCs 200(1), . . . and 200(N) are input according to the operation program input through the operation program input unit 160. Also, the main controller 110 calculates the profit and loss list with the profit and loss list operator 180 using a corresponding program on the profit and loss list operation program DB 170, which is input through the operation program input unit 160, and corresponding data on the number of holdings DB 140, the buy unit price DB 150, and the stock price information DB 190 and controls the output of operation result data.

The client DB 130 stores user IDs, passwords, account information, and personal information, and provides data required for determining whether the users of the client PCs 200(1), . . . and 200(N) are legal users when the users perform log-in in order to perform cyber trading. The number of holdings DB 140 stores data on the number of stocks held by a user and provides data on the number of holdings of a corresponding item of the user to the profit and loss list operator 180 according to the instructions of the main controller 110. The buy unit price DB 150 stores data on the buy price (the buy unit price of each stock) of the user and provides data on the buy unit price of a corresponding item of the user to the profit and loss list operator 180 according to the instructions of the main controller 110. The operation program input unit 160 inputs various management programs related to cyber securities trading, which are used by the main controller 110 by the manager of the profit and loss analysis system 100 and various profit and loss list operation programs for operating the profit and loss list.

The profit and loss list operation program DB 170 stores various profit and loss list operation programs input from the operation program input unit 160. The operation programs on the profit and loss list operation program DB 170 are transmitted to the profit and loss list operator 180 according to the instructions of the main controller 110. The various operation programs on the profit and loss list operation program DB 170 include commission ratio input variables.

A detailed description of processes of receiving other input variables such as the basic price, the number of buy, and the buy unit price, and operating the same will now be performed. The profit and loss list operator 180 performs operations using the operation programs and three input variables according to the control of the main controller 110. The profit and loss list is calculated using the corresponding operation program on the profit and loss list operation program DB 170, which is input from the program input unit 160; the number of holdings of a corresponding item, which is input from the number of holdings DB 140; the buy unit price of a corresponding item, which is input from the buy unit price DB 150; and the basic price of a corresponding item, which is input from the stock price information DB 190, and the operation result is transmitted to the main controller 110.

The stock price information DB 190 stores stock price information such as a basic price, a current price, a quotation, the number of sell at each quotation, the number of buys, a trading amount, and upper and lower limits. The stock price information DB 190 transmits the basic price of a corresponding item to the profit and loss list operator 180 according to the instructions of the main controller 110, and periodically outputs the quotation and information on the number of sell and buy of each quotation, which are periodically input from the Securities Computer Center, to a client PC.

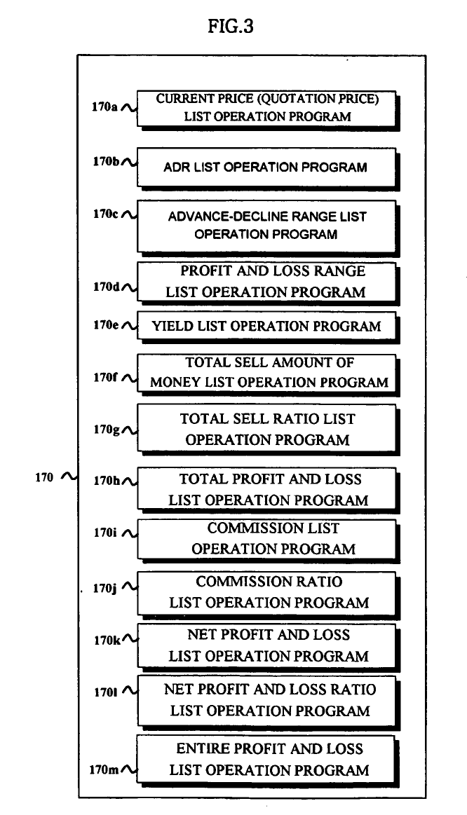

FIG. 3 shows a detailed structure of the profit and loss list operation program DB 170 of the profit and loss analysis system 100 according to the first embodiment of the present invention. The profit and loss list operation program DB 170 of the profit and loss analysis system 100 includes a stock price list operation program 170a, an advance-decline ratio (ADR) list operation program 170b, an advance-decline range list operation program 170c, a profit and loss range list operation program 170d, a yield list operation program 170e, a total sell amount of money list operation program 170f, a total sell ratio list operation program 170g, a total profit and loss list operation program 170h, a commission list operation program 170i, a commission ratio list operation program 170j, a net profit and loss list operation program 170k, a net profit and loss ratio list operation program 170l, and an entire profit and loss list operation program 170m. A new program can be added to the profit and loss list operation program DB 170, and some of the above programs can be deleted or changed.

The operations of the respective operation programs of the profit and loss list operation program DB 170 will now be described.

The current stock price list operation program 170a of the profit and loss list operation program DB 170 is a program for determination of a stock price list, to which a quotation unit is applied from the upper limit to the lower limit using the basic price of a corresponding item. After calculating the upper limit and the lower limit on the basis of the basic price of a corresponding item, which is an input item (1), the stock price list is calculated by applying the quotation unit from the upper limit to the lower limit (2). (e.g. The stock price list of an item whose basic price is 10,000 won (Korean currency) ranges between the upper limit 11,500 won and the lower limit 8,500 won. The quotation unit is 50 won when the stock price is more than 10,000 won, and it is 10 won when the stock price is less than 10,000. The number of stock prices is 180.) In the case of countries where there are no upper and lower limits, a range set by a user (e.g. ±20.0% and +30.0% through −5.0%) can be the upper and lower limits.

The ADR list operation program 170b calculates the ADR of each stock price on the stock price list of the corresponding item. The ADR is the ratio of each stock price rise and fall based on the basic price. ADR is ((stock price+basic price)−1)×100. In the ADR operation, after calculating the stock price list using the basic price of the corresponding item that is an input variable (1), each stock price on the stock price list is divided by the basic price (2). (e.g. The ADR of 11,500 won with respect to the basic price 10,000 won is 15.0%, and the ADR of 8,500 with respect to the basic price 10,000 won is −15.0%.)

The advance-decline range list operation program 170c calculates the advance-decline range with respect to each stock price on the stock price list. The advance-decline range is how much difference exists between a specific stock price and the basic price. The advance-decline range is stock price−basic price. In the advance-decline range operation, after calculating the stock price list using the basic price of the corresponding item that is the input variable (1), the basic price is subtracted from each stock price on the stock price list (2). (e.g. The advance-decline range of the stock price 11,500 won with respect to the basic price 10,000 won is 1,500 won and the advance-decline range of the stock price 8,500 won with respect to the basic price 10,000 won is −1,500 won.)

The profit and loss range list operation program 170d calculates a profit and loss amount of money of each stock with respect to each stock price on the stock price list. The profit and loss range represents an amount of profit or loss with respect to the buy unit price and a specific stock price. The profit and loss range is stock price−buy price. The input variables of the profit and loss range operation are the basic price and the buy unit price. In the profit and loss range operation, after calculating the stock price list using the basic price (1), the buy price is subtracted from each stock price on the stock price list (2). (e.g. The profit range of the stock price 11,500 won with respect to the buy unit price 10,500 won is +1,000 won, and the loss range of the stock price 8,500 won with respect to the buy unit price 10,500 won is −2,000 won.)

The yield list operation program 170e calculates the ratio of the sell unit price to the buy unit price with respect to a specific stock price on the stock price list. The yield is the profit and loss ratio a specific stock price has with respect to the buy unit price. The yield is ((stock price+buy price)−1)×100. The input variables of the yield operation are the basic price and the buy unit price. In the yield operation, after calculating the stock price list using the basic price (1), the buy price is subtracted from each stock price on the stock price list (2) and the resultant value is divided by the buy price (3). (e.g. The yield of the stock price 11,000 won with respect to the buy unit price 10,000 won is 10.0% and the yield of 9,500 won with respect to the buy unit price 10,000 won is −5.0%.)

The total sell amount of money list operation program 170f calculates the sell amount of money with respect to each stock price on the stock price list. The total sell amount of money is the sell amount of money obtained when the stocks are sold. The total sell amount of money is stock price×number of sell (holdings). The input variables of the total sell amount of money are the basic price and the number of holdings. In the total sell amount of money operation, after calculating the stock price list using the basic price (1), each stock price on the stock price list is multiplied by the number of sell (2). (e.g. When 200 stocks are sold at the current price 9,000 won, the total sell amount of money is 1,800,000 won.)

The total sell ratio list operation program 170g calculates the ratio of the sell amount of money to the buy amount of money with respect to each stock price on the stock price list. The total sell ratio is the ratio of the total sell amount of money to the total buy amount of money when stocks are sold at a specific stock price. The total sell ratio is (total sell amount of money+total buy amount of money)×100. The input variables of the total sell ratio operation are the basic price, the number of holdings, and the buy unit price. In the total sell ratio operation, the stock price list is calculated using the basic price sell ratio (1). The total sell amount of money of each stock price on the stock price list is calculated (2), the total buy amount of money is calculated (3), and the total sell amount of money is divided by the total buy amount of money (4). (e.g. When the number of holdings is 200, the buy price is 10,000 won, and the stock price is 10,800, the total sell ratio is 108.0%.)

The total profit and loss list operation program 170h calculates the loss or profit amount of money with respect to each stock price on the current price list. The total profit and loss is the profit and loss obtained when stocks are sold at a specific stock price. The total profit and loss is (stock price−buy price)×number of holdings, profit and loss range of each stock×number of holdings, or total sell amount of money−total buy amount of money. The input variables of the total profit and loss operation are the basic price, the number of holdings, and the buy unit price. In the total profit and loss operation, the stock price list using the basic price is calculated (1). The total sell amount of each stock price on the stock price list is calculated (2), the total buy amount of money is calculated (3), and the total buy amount of money is subtracted from the total sell amount of money (4). (e.g. When the number of holdings is 100, the buy price is 10,000 won, and the stock price is 11,000 won, the total profit and loss is 100,000 won.)

The commission list operation program 170i calculates a commission with respect to each stock price on the stock price list. The commission is the fee to be paid according to the scale of a trading amount of money when stocks are sold at a specific stock price. The commission is ((total buy amount of money×commission ratio)+basic fee)+(total sell amount of money×(commission ratio+government tax ratio)+basic fee). The input variables of the commission operation are the basic price, the number of holdings, the buy unit price, and the commission. In the commission operation, the stock price list is calculated using the basic price (1). The sell amount of money commission and the buy amount of money commission of each stock price on the stock price list are calculated (2), and the sell amount of money commission is added to the buy amount of money commission (3). (e.g. When the commission ratio is 0.3%, the basic fee is 1,000 won, the number of holdings is 100, the buy price is 10,000 won, and the stock price is 11,000, the commission is 6,500 won.)

The commission ratio list operation program 170j calculates the ratio of the commission to the trading amount of money with respect to each stock price on the stock price list. The commission ratio is a ratio the commission to be paid occupies in the trading scale when stocks are sold at a specific stock price. The commission is (commission+(total buy amount of money+total sell amount of money))×100. The input variables of the commission ratio operation are the basic price, the number of holdings, the buy unit price, and the commission ratio. In the commission ratio operation, the stock price list is calculated using the basic price (1). The commission ratio of each stock price on the stock price list is calculated (2), the trading amount of money is calculated (3), and the commission ratio is divided by the trading amount of money. (e.g. When the commission ratio is 0.3%, the number of holdings is 100, the buy price is 10,000 won, and the stock price is 11,000 won, the commission ratio is 0.314%.)

The net profit and loss list operation program 170k calculates the net profit and loss with respect to each stock price on the stock price list. The net profit and loss is the finally left profit and loss after subtracting the commission from the total profit and loss when stocks are sold at a specific stock price. The net profit and loss is total sell amount of money−total buy amount of money−commission, or total profit and loss−commission. The input variables of the net profit and loss operation are the basic price, the number of holdings, the buy unit price, and the commission ratio. In the net profit and loss operation, the stock price list is calculated using the basic price (1). The total sell amount of money of each stock price on the stock price list is calculated (2), the total buy amount of money is calculated (3), the commission is calculated (4), and the commission is subtracted from the total profit and loss (5). (e.g. When the number of holdings is 100, the buy price is 10,000 won, the stock price is 11,000 won, and the commission is 6,300 won, the net profit and loss is 93,700 won (total profit and loss 100,000 won−commission 6,300 won).)

The net profit and loss ratio list operation program 170l calculates the ratio of the net profit and loss to the buy amount of money with respect to each stock price on the stock price list. The net profit and loss ratio is the ratio of the buy amount of money to the net profit and loss finally left after subtracting the commission from the total profit and loss when stocks are sold at a specific stock price. The net profit and loss ratio is ((total sell amount of money−total buy amount of money−commission)+total buy amount of money)×100. The input variables of the net profit and loss ratio operation are the basic price, the number of holdings, the buy unit price, and the commission. In the net profit and loss ratio operation, the stock price list is calculated using the basic price (1), the total sell amount of each stock price on the stock price list is calculated (2), the total buy amount of money is calculated (3), the commission is calculated (4), the net profit and loss is calculated by subtracting the commission from the net profit and loss (5), and the net profit and loss is divided by the total buy amount of money. (e.g. When the number of holdings is 100, the buy price is 10,000 won, the current price is 11,000 won, the commission is 6,300 won, and the net profit and loss is 93,700 won, the net profit and loss ratio is 9.37%.)

The entire profit and loss list operation program 170m calculates all the profit and loss values with respect to each stock price on the stock price list. The entire profit and loss items are the ADR, the advance-decline range, the profit and loss range, the yield, the total sell amount of money, the total sell ratio, the total profit and loss, the commission, the commission ratio, the net profit and loss, and the net profit and loss ratio, that are obtained when stocks are sold at a specific price. The input variables of the entire profit and loss list operation are the basic price, the number of holdings, the buy unit price, and the commission ratio. In the operation of the profit and loss list operation program, the stock price list is calculated using the basic price (1), the ADR is calculated (2), the advance-decline range is calculated (3), the profit and loss range is calculated (4), the yield is calculated (5), the total sell amount of money is calculated (6), the total sell ratio is calculated (7), the total profit and loss is calculated (8), the commission is calculated (9), the commission ratio is calculated (10), the net profit and loss is calculated (11), and the net profit and loss ratio is calculated (12). The input variables required for the operation of the profit and loss list operation program are the basic price, the buy unit price, the number of holdings, and the commission ratio. All of the above operation programs perform their operations selectively using the four variables.

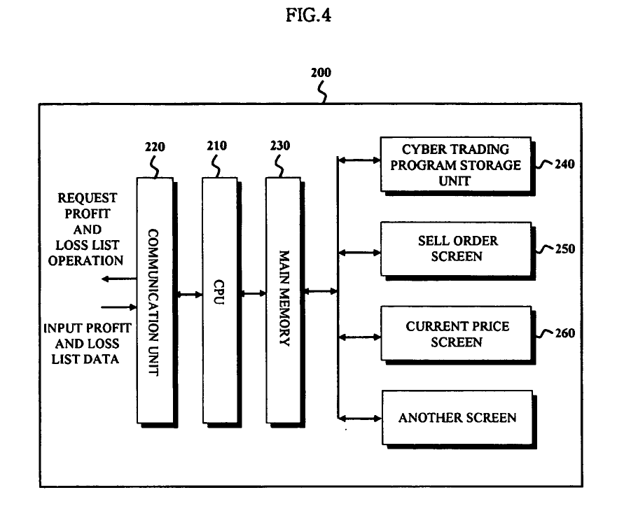

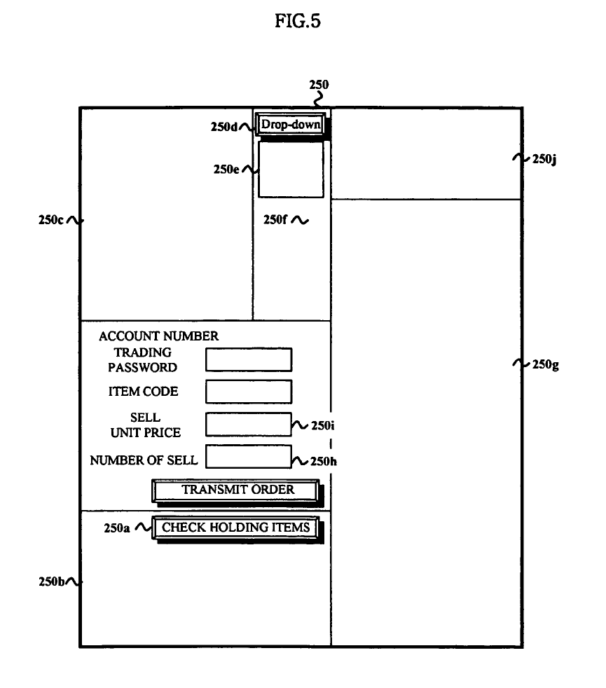

FIG. 4 shows a structure of a cyber trading system 200 in a client PC in a cyber trading service apparatus according to an embodiment of the present invention.

Referring to FIG. 4, the cyber trading system 200 in the client PC includes a central processing unit (CPU) 210, a communication unit 220, a main memory 230, a cyber trading program storage unit 240, and a sell order screen 250.

The communication unit 220 performs wire and wireless communications related to the calculation of the profit and loss list between the client PCs 200(1), . . . and 200(N) and the profit and loss analysis system 100. The communication unit 220 outputs an operation performance key signal, an account number, an item code, and a profit and loss item code according to the selection of the drop-down button by the respective users to the profit and loss analysis system 100, and receives the profit and loss list from the profit and loss analysis system 100.

The CPU 210 controls the outputs of the operation performance key signal, the account number, the item code, and the profit and loss item code according to the selection of the drop-down button by the users. Also, the CPU 210 displays data on the quotations of the corresponding items and the number of sell and buy of each quotation, which is periodically input from the profit and loss analysis system 100 through the communication unit 220 (1), stores the input profit and loss list data in the main memory (2), displays the profit and loss data corresponding to the corresponding quotation of a quotation information window (3), and shows the entire data on the profit and loss list on the profit and loss list window (4).

The main memory 230 temporarily stores the corresponding program of the cyber trading program storage unit 240 and temporarily stores the profit and loss list data input from the profit and loss analysis system 100 according to the control of the CPU 210.

The cyber trading program storage unit 240 stores the emulator program that is only for cyber trading and is automatically downloaded from the profit and loss analysis system 100 after log in.

The sell order screen 250 displays information on the quotation of the corresponding item and information on the profit and loss list and outputs data on the number of sell and the sell unit price, which is input by the users in order to sell stocks, to the profit and loss analysis system 100 according to the control of the CPU 210.

FIG. 5 shows the sell order screen 250 of the cyber trading system 200 in the client PC according to a first embodiment of the present invention.

The sell order screen 250 of the cyber trading system 200 includes a holding item checking button 250a, a holding item information window 250b, a quotation information window 250c, a drop-down button 250d, a profit and loss item list window 250e, a profit and loss list by quotation window 250f, a profit and loss list window 250g, a number of sell input blank 250h, a sell unit price input blank 250i, and an overall calculation window 250j.

The holding item checking button 250a of the sell order screen 250 is selected by users in order to check the item held by the users.

The holding item information window 250b receives the holding items, the number of holdings, and the buy unit price of the account of the user from the profit and loss analysis system 100 according to the selection of the holding item checking button 250a by the user and displays them.

When a user selects a specific item in the holding item information window 250b, the data on the quotation and the number of sell and buys is periodically received from the profit and loss analysis system 100 and is displayed on the quotation information window 250c. Also, the quotation information window 250c highlights rows corresponding to the sell price and the buy price with different colors so that the user can distinguish the sell price from the buy price, performs a sell canceling command when the user selects the sell canceling order with the right mouse button at the sell price, and performs a sell price correcting order when the user drags the mouse to another sell price or selects another price.

The drop-down button 250d displays various profit and loss item lists.

The profit and loss item list window 250e enumerates the profit and loss items according to the selection of the drop-down button 250d by the user and lets the user select a specific profit and loss item. The ADR, the advance-decline range, the profit and loss range, the yield, the total sell amount of money, the total sell ratio, the total profit and loss, the commission, the commission ratio, the net profit and loss, the net profit and loss ratio, and the entire profit and loss are displayed on the profit and loss item list window 250e.

The profit and loss list by quotation window 250f displays the profit and loss data corresponding to the quotation within the quotation publication range, which is input from the profit and loss analysis system 100, and displays the profit and loss data corresponding to the changed quotation when the quotation is changed.

The profit and loss list window 250g displays the entire profit and loss list data input from the profit and loss analysis system 100. Also, the profit and loss list window 250g highlights the rows corresponding to the sell price and the buy price with different colors so that the user can distinguish the sell price from the buy price, performs a sell canceling command when the user selects the sell canceling order with the right mouse button at the sell price, and performs a sell price correcting order when the user drags the mouse to another sell price or selects another price, as in the quotation information window 250c.

When the user selects a specific quotation in the quotation information window 250c or a specific stock price (a specific row) in the profit and loss list window 250g, the sell unit price input blank 250i automatically receives the stock price corresponding to a specific row and the number of sell input blank 250h automatically receives the number of holdings in the holding item information window 250b.

When the user selects a specific quotation in the quotation information window 250c or a specific stock price (a specific row) in the profit and loss list window 250g in order to input a sell order, the overall calculation window 250j displays various profit and loss resultant values calculated using the sell price, the buy price, and the number of holdings.

The operation of the cyber trading service apparatus and method according to the first embodiment of the present invention will now be described in detail with reference to the attached drawings.

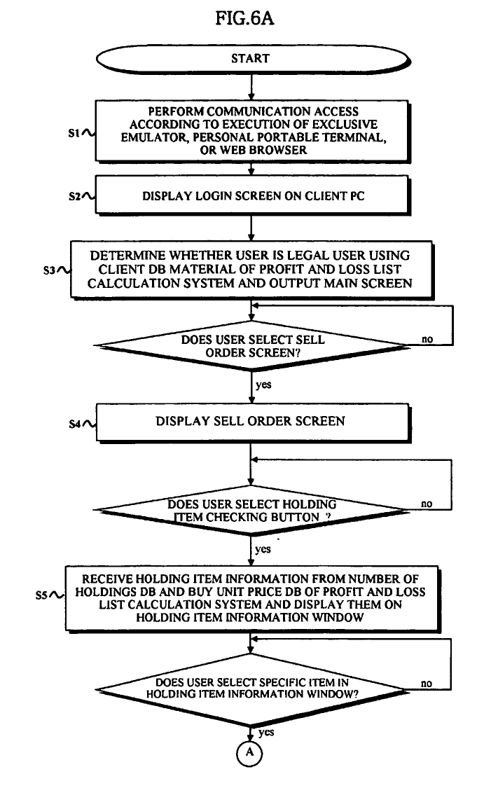

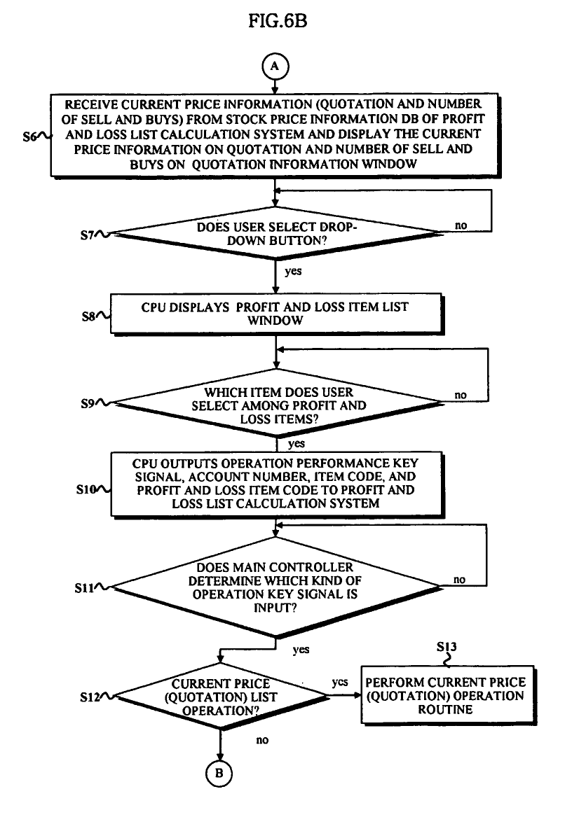

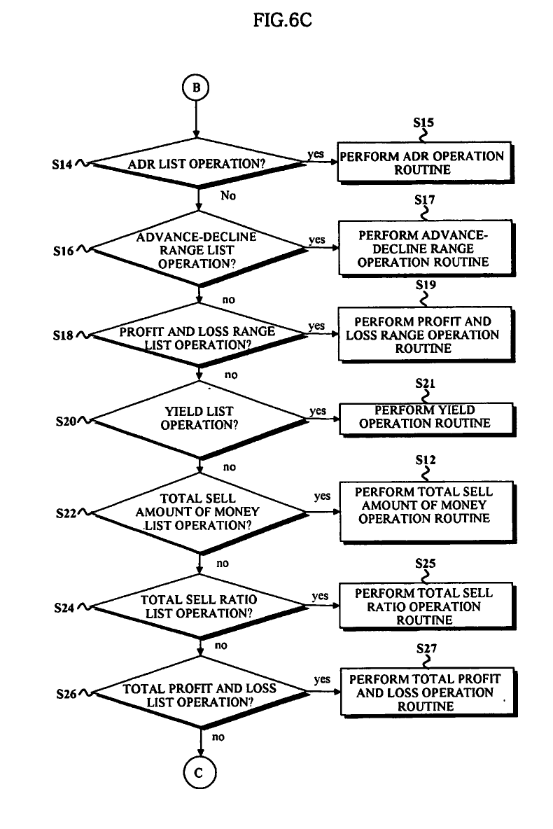

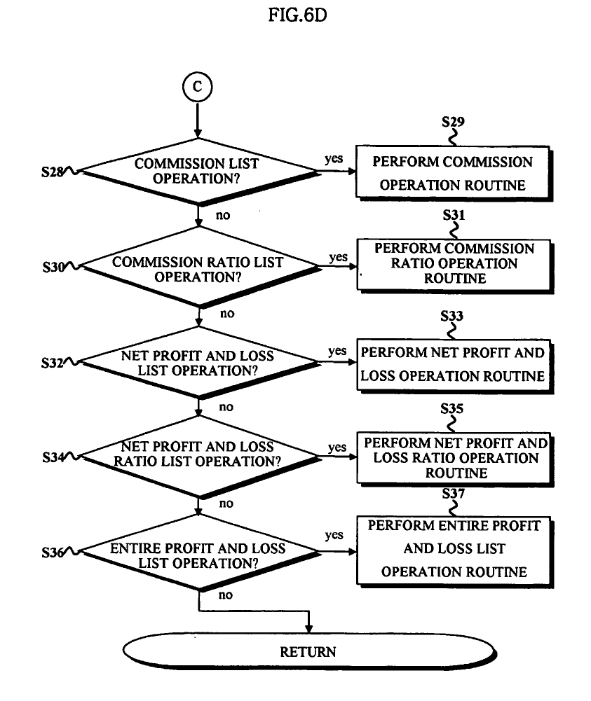

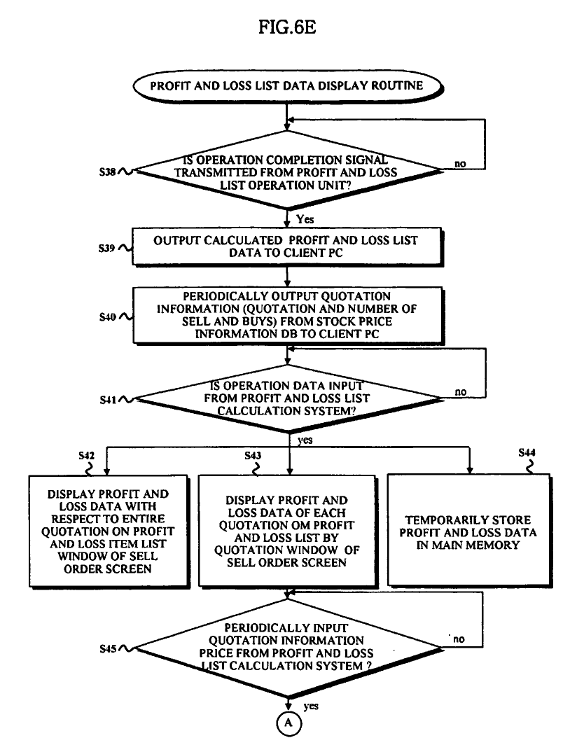

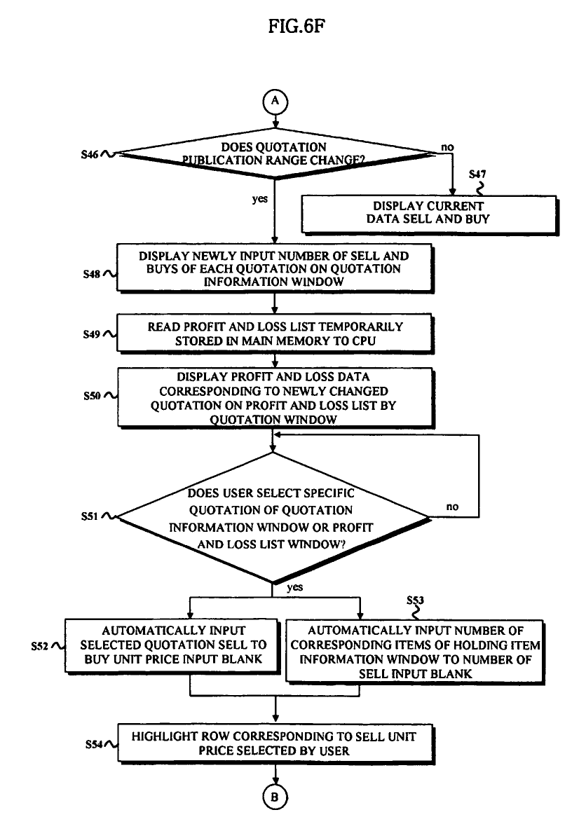

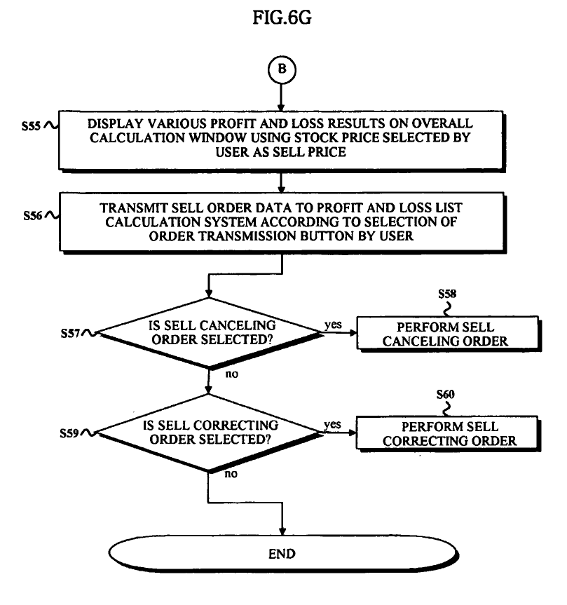

FIGS. 6A through 6G are flowcharts showing the operations of a cyber trading service method according to an embodiment of the present invention.

As shown in FIGS. 6A through 6G, the emulator that is only for cyber trading or the web browser installed in the client PC 200 is executed by the users, and the client PC 200 accesses the profit and loss analysis system 100 of each securities company through the network communication network 300 (S1).

When the client PC 200 accesses the profit and loss analysis system 100, the client PC 200 receives user login screen data output from the profit and loss analysis system 100 and displays the screen data on a main screen so that the user can check the data (S2).

The client PC 200 outputs login data such as an ID and a password input by the user to the login screen, to the profit and loss analysis system 100. The main controller 110 of the profit and loss analysis system 100 determines whether the login data such as the ID and the password input by the user coincide with registered data on the client DB 130. When it is determined that the user is a registered user, the main controller 110 outputs the main screen of the cyber trading system (S3).

When the user selects the sell order screen 250, the CPU 210 loads the sell order screen 250 from the cyber trading program storage unit 240 and displays the sell order screen 250 on a screen (S4).

When the user selects the holding item checking button 250a on the sell order, screen 250, the CPU 210 receives information on the holding items from the profit and loss analysis system 100 and displays the information on the holding item information window 250b (S5).

When the user selects a specific item among the holding items displayed on the holding item information window 250b such as stocks, futures, and options, the CPU 210 periodically receives information on the current price of the corresponding item such as data on the quotation and the number of sell and buys of each quotation and other stock information from the profit and loss analysis system 100, and displays the information on the quotation information window 250c (S6).

The technologies of the above processes S1 through S6 are well known in the cyber trading system. That is, because it is a well-known function and process that the current price information is displayed when the user inputs a specific item code or selects a holding item on the sell order screen, a detailed description thereof will be omitted.

When the user selects the drop-down button 250d in order to grasp stock prices from the upper limit to the lower limit of the corresponding item and to know various profits and losses corresponding to the respective stock prices (S7), the CPU 210 displays the profit and loss item list window 250e (S8).

When the user selects a specific profit and loss item among the profit and loss items enumerated on the profit and loss item list window 250e (S9), the CPU 210 outputs the profit and loss list operation performance key signal, the account number, the item code, and the selected profit and loss item code to the profit and loss analysis system 100 through the communication unit 220 (S10).

The main controller 110 of the profit and loss analysis system 100 determines whether a profit and loss list operation performance key signal and the corresponding data are input from the client PC 200 through the communication controller 110 (S11).

When it is determined that the operation performance key signal is input, the main controller 110 determines which kind of profit and loss list is to be calculated (S12, S14, S16, S18, S20, S22, S24, S26, S28, S30, S32, S34, or S36).

When it is determined in step S12 that a stock price list operation command is input, the main controller 110 performs a stock price list operation routine (S13).

When it is determined in step S14 that an ADR list operation command is input, the main controller 110 performs an ADR list operation routine (S15).

When it is determined in step S16 that an advance-decline range list operation command is input, the main controller 110 performs an advance-decline range list operation routine (S17).

When it is determined in step S18 that a profit and loss range list operation command is input, the main controller 110 performs a profit and loss range list operation routine (S19).

When it is determined in step S20 that a yield list operation command is input, the main controller 110 performs a yield list operation routine (S21).

When it is determined in step S22 that a total sell amount of money list operation command is input, the main controller 110 performs a total sell amount of money list operation routine (S23).

When it is determined in step S24 that a total sell ratio list operation command is input, the main controller 110 performs a total sell ratio list operation routine (S25).

When it is determined in step S26 that a total profit and loss list operation command is input, the main controller 110 performs a total profit and loss list operation routine (S27).

When it is determined in step S28 that a commission list operation command is input, the main controller 110 performs a commission list operation routine (S29).

When it is determined in step S30 that a commission ratio list operation command is input, the main controller 110 performs a commission ratio list operation routine (S31).

When it is determined in step S32 that a net profit and loss list operation command is input, the main controller 110 performs a net profit and loss list operation routine (S33).

When it is determined in step S34 that a net profit and loss ratio list operation command is input, the main controller 110 performs a net profit and loss ratio list operation routine (S35).

When it is determined in step S36 that an entire profit and loss list operation command is input, the main controller 110 performs an entire profit and loss list operation routine (S37).

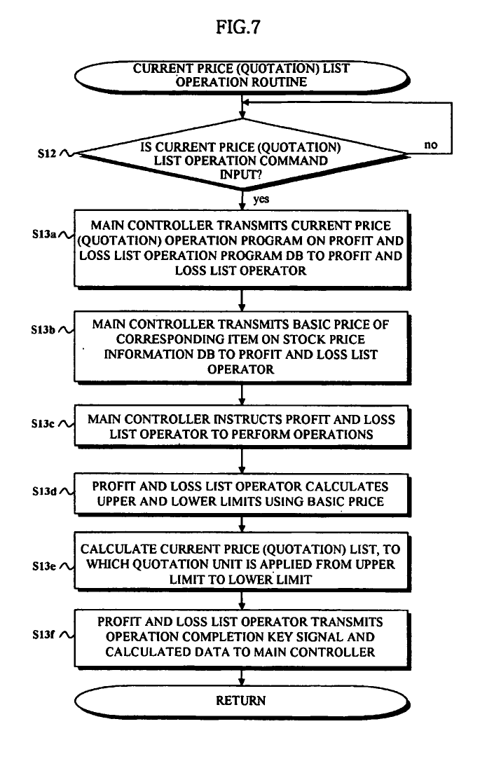

FIG. 7 shows the stock price list operation routine (S13).

When it is determined in the step S12 that the stock price list operation command is input, the main controller 110 transmits the stock price list operation program 170a on the profit and loss list operation program DB 170 to the profit and loss list operator 180 (S13a), transmits the basic price of the corresponding item on the stock price information DB 190 to the profit and loss list operator 180 (S13b), and instructs the profit and loss list operator 180 to perform operations (S13c).

The profit and loss list operator 180 inputs the basic price of the corresponding item to the stock price list operation program 170a, to thus calculate the upper and lower limit (S13d); and calculates the stock price list, to which the quotation limit is applied from the upper limit to the lower limit (S13e), according to the operation command from the main controller 110. The profit and loss list operator 180 transmits an operation completion signal and calculated data to the main controller 110 (S13f).

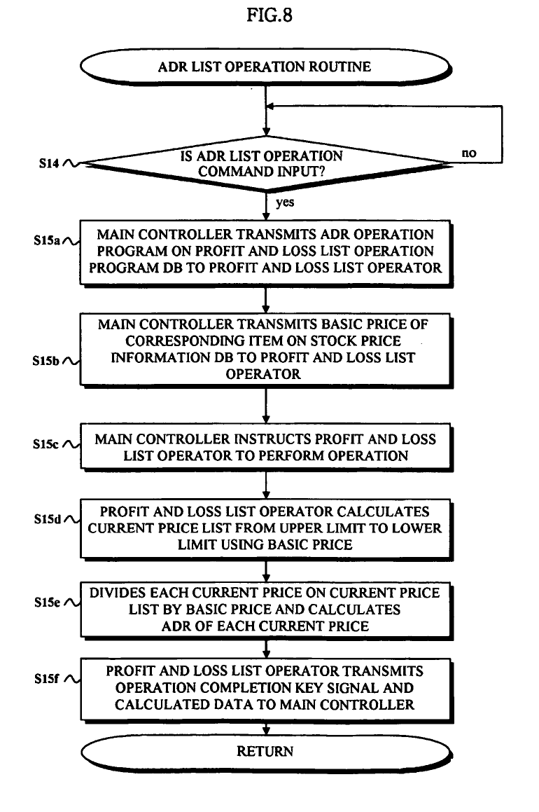

FIG. 8 shows the ADR list operation routine (S15). When it is determined in the step S14 that the ADR list operation command is input, the main controller 110 transmits the ADR list operation program 170b on the profit and loss list operation program DB 170 to the profit and loss list operator 180 (S15a), transmits the basic price of the corresponding item on the stock price information DB 190 to the profit and loss list operator 180 (S15b), and instructs the profit and loss list operator 180 to perform operations (S15c).

The profit and loss list operator 180 inputs the basic price of the corresponding item to the ADR list operation program 170b, to thus calculate the stock price list (S15d);and divides each stock price on the stock price list by the basic price, to thus calculate the ADR of each stock price (S15e). The profit and loss list operator 180 transmits the operation completion signal and the calculated data to the main controller 110 (S15f).

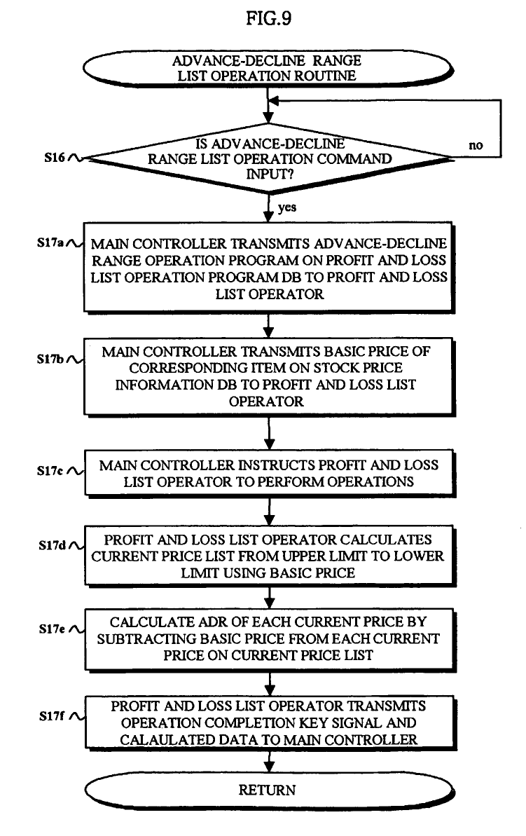

FIG. 9 shows the advance-decline range list operation routine (S17). When it is determined in the step S16 that the advance-decline range list operation command is input, the main controller 110 transmits the advance-decline range list operation program 170c on the profit and loss list operation program DB 170 to the profit and loss list operator 180 (S17a), transmits the basic price of the corresponding item on the stock price information DB 190 to the profit and loss list operator 180 (S15b), and instructs the profit and loss list operator 180 to perform operations (S15c).

The profit and loss list operator 180 inputs the basic price of the corresponding item to the advance-decline width list operation program 170c, to thus calculate the stock price list (S17d); and subtracts the basic price from each stock price on the current price list, to thus calculate the advance-decline range of each stock price (S17e), according to the operation command from the main controller 110. The profit and loss list operator 180 transmits the operation completion signal and the calculated data to the main controller 110 (S17f).

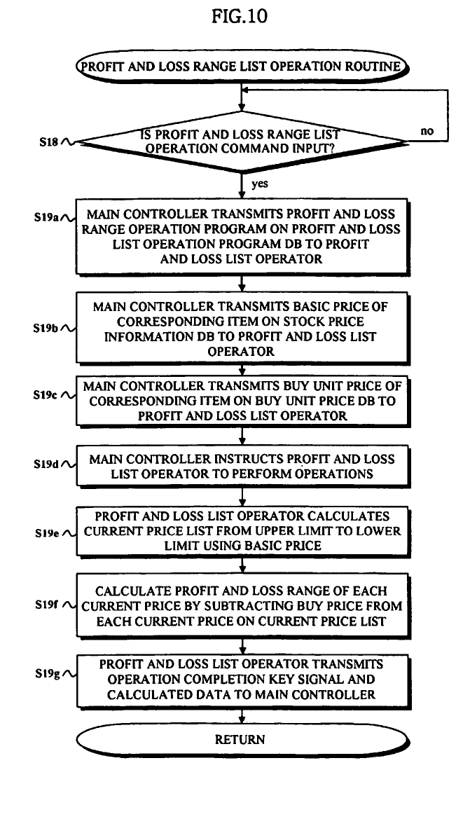

FIG. 10 shows the profit and loss list operation routine (S19). When it is determined in the step S18 that the profit and loss range list operation command is input, the main controller 110 transmits the profit and loss range list operation program 170d on the profit and loss list operation program DB 170 to the profit and loss list operator 180 (S19a), transmits the basic price of the corresponding item on the stock price information DB 190 to the profit and loss list operator 180 (S19b), transmits the buy unit price of the corresponding item on the buy unit price DB 150 to the profit and loss list operator 180 (S19c), and instructs the profit and loss list operator 180 to perform operations (S19d).

The profit and loss list operator 180 calculates the stock price list using the basic price of the corresponding item (S19e) and subtracts the buy unit price from each stock price on the stock price list, to thus calculate the profit and loss range of each stock price (S17f), according to the operation command from the main controller 110. The profit and loss list operator 180 transmits the operation completion signal and the calculated data to the main controller 110 (S17g).

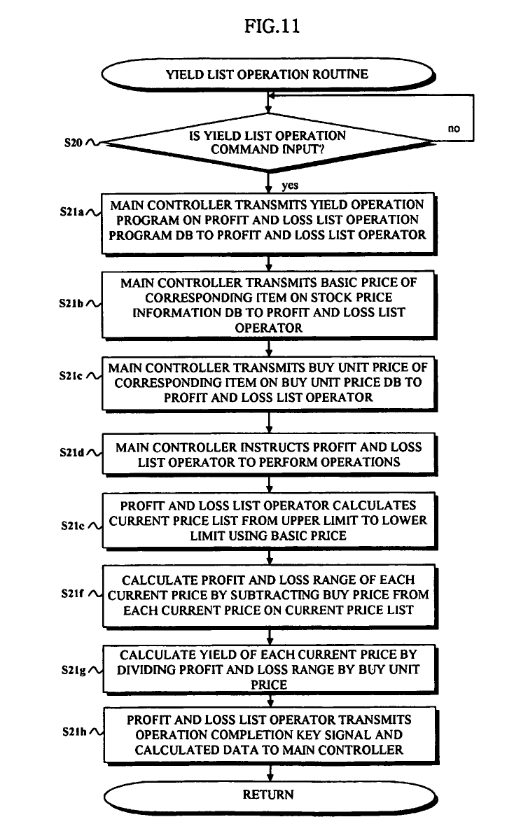

FIG. 11 shows the yield list operation routine (S21). When it is determined in the step S20 that the yield list operation command is input, the main controller 110 transmits the yield list operation program 170e on the profit and loss list operation program DB 170 to the profit and loss list operator 180 (S21a), transmits the basic price of the corresponding item on the stock price information DB 190 to the profit and loss list operator 180 (S21b), transmits the buy unit price of the corresponding item on the buy unit price DB 150 to the profit and loss list operator 180 (S21c), and instructs the profit and loss list operator 180 to perform operations (S21d).

The profit and loss list operator 180 calculates the stock price list using the basic price of the corresponding item (S21e), subtracts the buy unit price from each stock price on the stock price list, to thus calculate the profit and loss range (S21f); and divides the profit and loss range by the buy unit price, to thus calculate the yield of each stock price (S21g), according to the operation command from the main controller 110. The profit and loss list operator 180 transmits the operation completion signal and the calculated data to the main controller 110 (S21h).

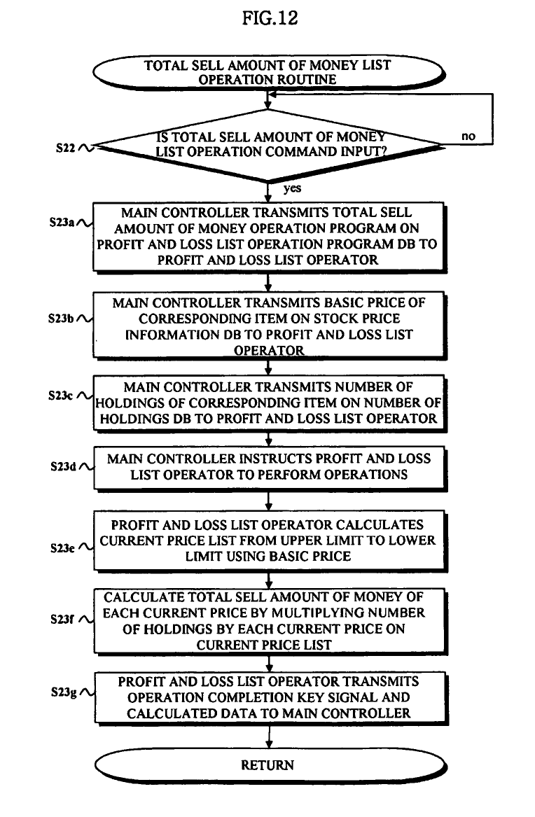

FIG. 12 shows the total sell amount of money list operation routine (S23). When it is determined in the step S22 that the total sell amount of money list operation command is input, the main controller 110 transmits the total sell amount of money list operation program 170f on the profit and loss list operation program DB 170 to the profit and loss list operator 180 (S23a), transmits the basic price of the corresponding item on the stock price information DB 190 to the profit and loss list operator 180 (S23b), transmits the number of holdings of the corresponding item on the number of holdings DB 140 to the profit and loss list operator 180 (S23c), and instructs the profit and loss list operator 180 to perform operations (S23d).

The profit and loss list operator 180 calculates the stock price list using the basic price of the corresponding item (S23e) and multiplies each stock price on the stock price list by the number of holdings, to thus calculate the total sell amount of money of each stock price (S23f), according to the operation command from the main controller 110. The profit and loss list operator 180 transmits the operation completion signal and the calculated data to the main controller 110 (S23g).

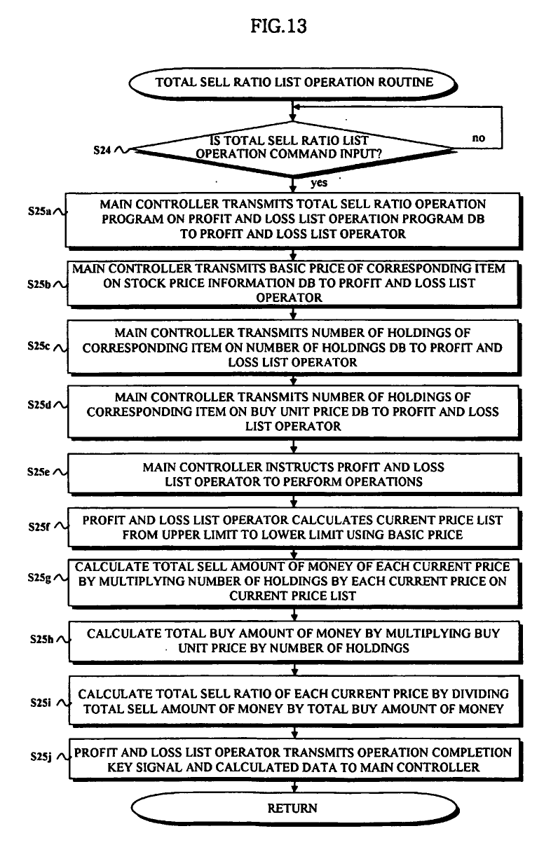

FIG. 13 shows the total sell ratio list operation routine (S25). When it is determined in the step S24 that the total sell ratio list operation command is input, the main controller 110 transmits the total sell ratio list operation program 170g on the profit and loss list operation program DB 170 to the profit and loss list operator 180 (S25a), transmits the basic price of the corresponding item on the stock price information DB 190 to the profit and loss list operator 180 (S25b), transmits the number of holdings of the corresponding item on the number of holdings DB 140 to the profit and loss list operator 180 (S25c), transmits the buy unit price of the corresponding item on the buy unit price DB 150 to the profit and loss list operator 180 (S25d), and instructs the profit and loss list operator 180 to perform operations (S25e).

The profit and loss list operator 180 calculates the stock price list using the basic price of the corresponding item (S25f); multiplies each stock price on the stock price list by the number of holdings, to thus calculate the total sell amount of money (S25g); multiplies the number of holdings by the buy unit price, to thus calculate the total buy amount of money (S25h); and divides the total sell amount of money by the total buy amount of money, to thus calculate the total sell ratio of each stock price (S25i), according to the operation command from the main controller 110. The profit and loss list operator 180 transmits the operation completion signal and the calculated data to the main controller 110 (S25j).

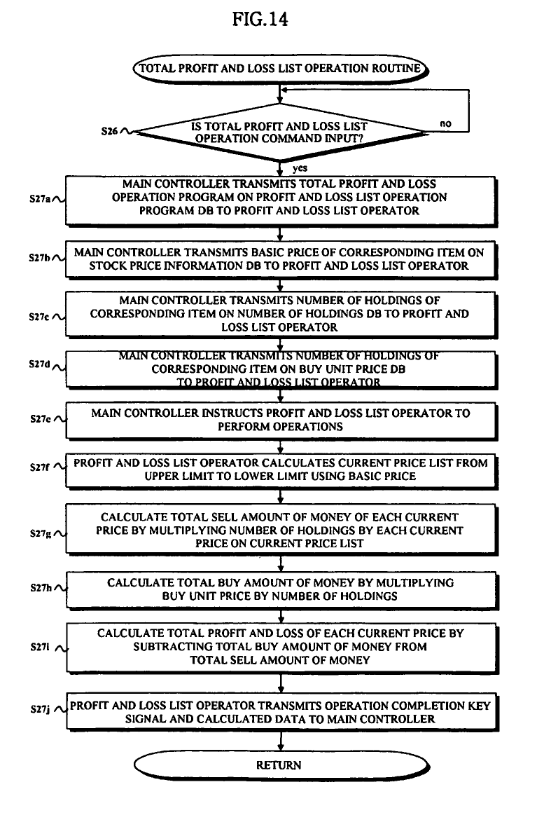

FIG. 14 shows the total profit and loss list operation routine (S27). When it is determined in the step S26 that the total profit and loss list operation command is input, the main controller 110 transmits the total profit and loss list operation program 170h on the profit and loss list operation program DB 170 to the profit and loss list operator 180 (S27a), transmits the basic price of the corresponding item on the stock price information DB 190 to the profit and loss list operator 180 (S27b), transmits the number of holdings of the corresponding item on the number of holdings DB 140 to the profit and loss list operator 180 (S27c), transmits the buy unit price of the corresponding item on the buy unit price DB 150 to the profit and loss list operator 180 (S27d), and instructs the profit and loss list operator 180 to perform operations (S27e).

The profit and loss list operator 180 calculates the stock price list using the basic price of the corresponding item (S27f); multiplies each stock price on the stock price list by the number of holdings, to thus calculate the total sell amount of money (S27g); multiplies the number of holdings by the buy unit price, to thus calculate the total buy amount of money (S27h); and subtracts the total buy amount of money from the total sell amount of money, to thus calculate the total profit and loss of each stock price (S27i), according to the operation command from the main controller 110. The profit and loss list operator 180 transmits the operation completion signal and the calculated data to the main controller 110 (S27j).

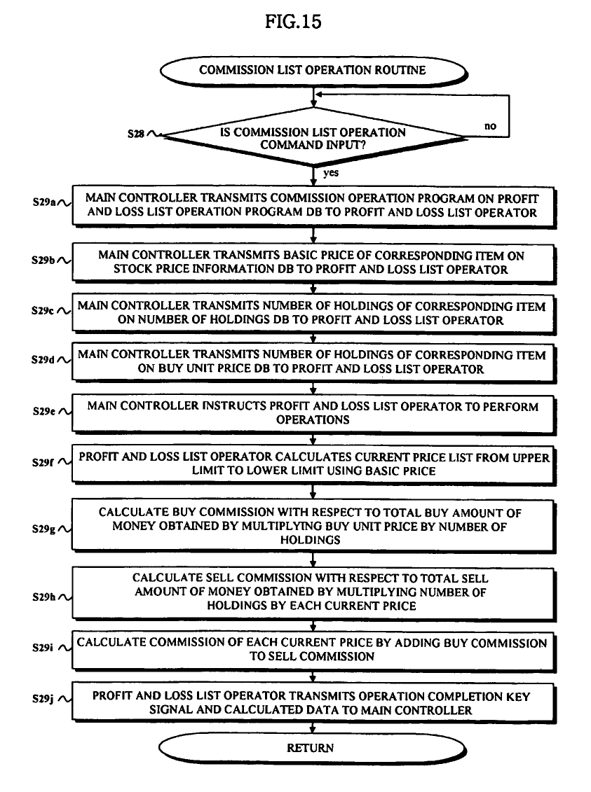

FIG. 15 shows the commission list operation routine S29. When it is determined in the step S28 that the commission list operation command is input, the main controller 110 transmits the commission list operation program 170i on the profit and loss list operation program DB 170 to the profit and loss list operator 180 (S29a), transmits the basic price of the corresponding item on the stock price information DB 190 to the profit and loss list operator 180 (S29b), transmits the number of holdings of the corresponding item on the number of holdings DB 140 to the profit and loss list operator 180 (S29c), transmits the buy unit price of the corresponding item on the buy unit price DB 150 to the profit and loss list operator 180 (S29d), and instructs the profit and loss list operator 180 to perform operations (S29e).

The profit and loss list operator 180 calculates the stock price list using the basic price of the corresponding item (S29f); multiplies the total buy amount of money obtained by multiplying the number of holdings by the buy unit price by the commission ratio, to thus calculate the buy commission (S29g); multiplies the total sell amount of money obtained by multiplying each stock price on the stock price list by the number of holdings by the commission ratio, to thus calculate the sell commission (S29h); and adds the buy commission to the sell commission, to thus calculate the commission of each stock price (S29i), according to the operation command from the main controller 110. The profit and loss list operator 180 transmits the operation completion signal and the calculated data to the main controller 110 (S29j).

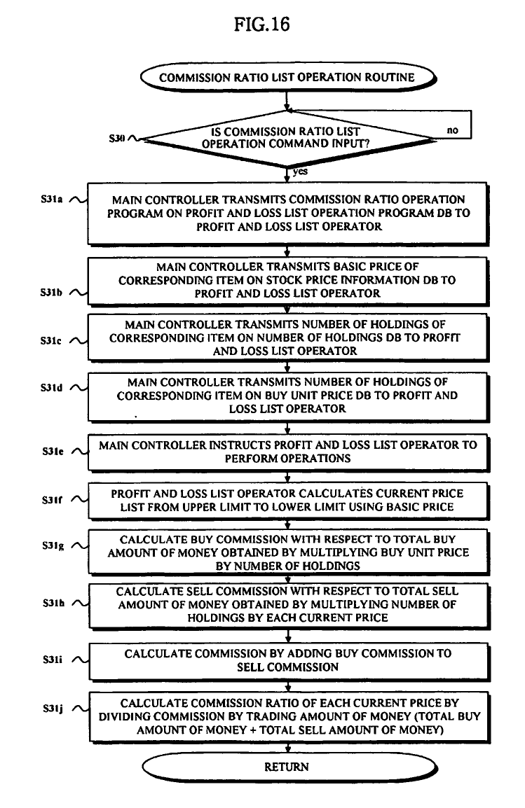

FIG. 16 shows the commission ratio list operation routine (S31). When it is determined in the step S30 that the commission ratio list operation command is input, the main controller 110 transmits the commission ratio list operation program 170j on the profit and loss list operation program DB 170 to the profit and loss list operator 180 (S31a), transmits the basic price of the corresponding item on the stock price information DB 190 to the profit and loss list operator 180 (S31b), transmits the number of holdings of the corresponding item on the number of holdings DB 140 to the profit and loss list operator 180 (S31c), transmits the buy unit price of the corresponding item on the buy unit price DB 150 to the profit and loss list operator 180 (S31d), and instructs the profit and loss list operator 180 to perform operations (S31e).

The profit and loss list operator 180 calculates the stock price list using the basic price of the corresponding item (S31f); adds the buy commission ratio to the sell commission ratio, to thus calculate the commission (S31g); adds the total buy amount of money to the total sell amount of money, to thus calculate the trading amount of money (S31h); and divides the commission by the trading amount of money, to thus calculate the commission ratio of each stock price (S31i), according to the operation command from the main controller 110.

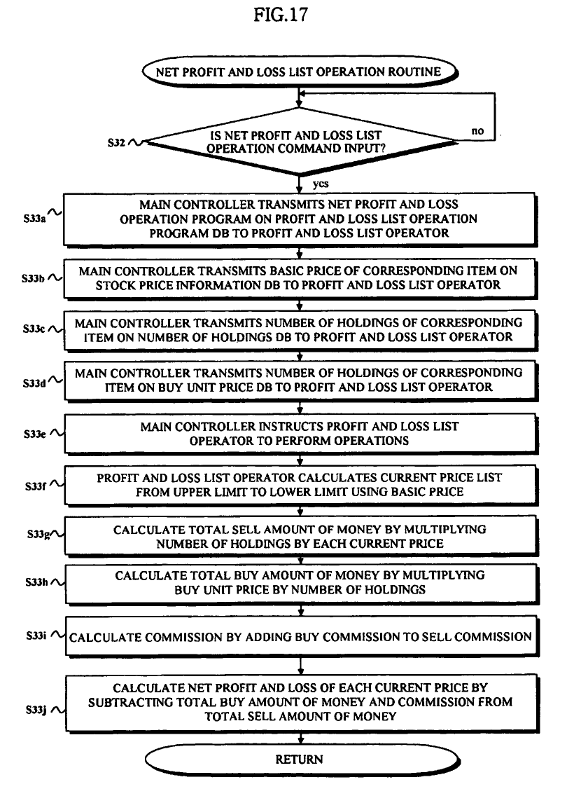

FIG. 17 shows the net profit and loss list operation routine S33. When it is determined in the step S32 that the net profit and loss list operation command is input, the main controller 110 transmits the net profit and loss list operation program 170k on the profit and loss list operation program DB 170 to the profit and loss list operator 180 (S33a), transmits the basic price of the corresponding item on the stock price information DB 190 to the profit and loss list operator 180 (S33b), transmits the number of holdings of the corresponding item on the number of holdings DB 140 to the profit and loss list operator 180 (S33c), transmits the buy unit price of the corresponding item on the buy unit price DB 150 to the profit and loss list operator 180 (S33d), and instructs the profit and loss list operator 180 to perform operations (S33e).

The profit and loss list operator 180 calculates the stock price list using the basic price of the corresponding item (S33f); multiplies each stock price on the stock price list by the number of holdings, to thus calculate the total sell amount of money (S33g); multiplies the number of holdings by the buy unit price, to thus calculate the total buy amount of money (S33h); adds the buy commission to the sell commission, to thus calculate the commission (S33i); and subtracts the total buy amount of money and the commission from the total sell amount of money, to thus calculate the net profit and loss of each stock price (S33j), according to the operation command from the main controller 110. The profit and loss list operator 180 transmits the operation completion signal and the calculated data to the main controller 110 (S33k).

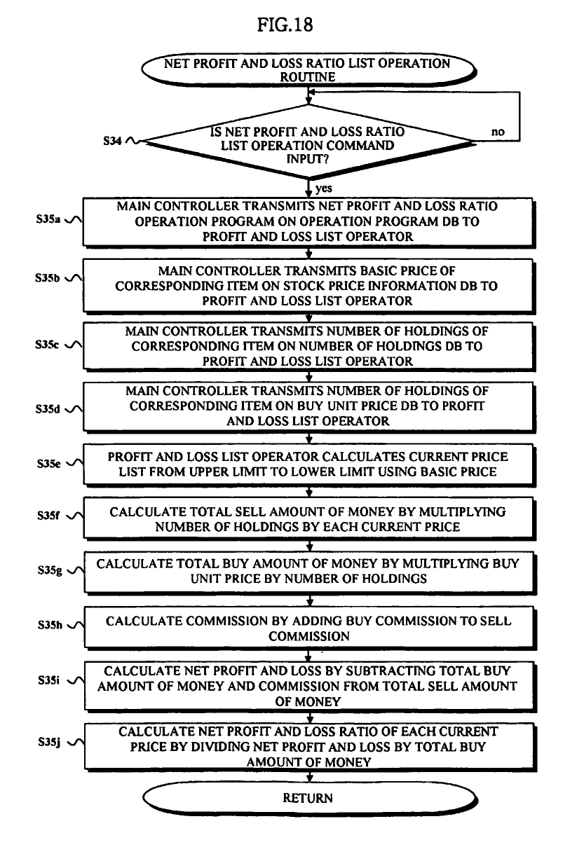

FIG. 18 shows the net profit and loss ratio list operation routine S35. When it is determined in the step S34 that the net profit and loss ratio list operation command is input, the main controller 110 transmits the net profit and loss ratio list operation program 170l on the profit and loss list operation program DB 170 to the profit and loss list operator 180 (S35a), transmits the basic price of the corresponding item on the stock price information DB 190 to the profit and loss list operator 180 (S35b), transmits the number of holdings of the corresponding item on the number of holdings DB 140 to the profit and loss list operator 180 (S35c), transmits the buy unit price of the corresponding item on the buy unit price DB 150 to the profit and loss list operator 180 (S35d), and instructs the profit and loss list operator 180 to perform operations (S35e).

The profit and loss list operator 180 calculates the stock price list using the basic price of the corresponding item (S35f); multiplies each stock price on the stock price list by the number of holdings, to thus calculate the total sell amount of money (S35g); multiplies the number of holdings by the sell unit price, to thus calculate the total buy amount of money (S35h); adds the sell commission to the buy commission, to thus calculate the commission (S35i); subtracts the total buy amount of money and the commission from the total sell amount of money, to thus calculate the net profit and loss (S35j); and divides the net profit and loss by the total buy amount of money, to thus calculate the net profit and loss ratio of each stock price (S35k). The profit and loss list operator 180 transmits the operation completion signal and the calculated data to the main controller (S33l), according to the operation command from the main controller 110.

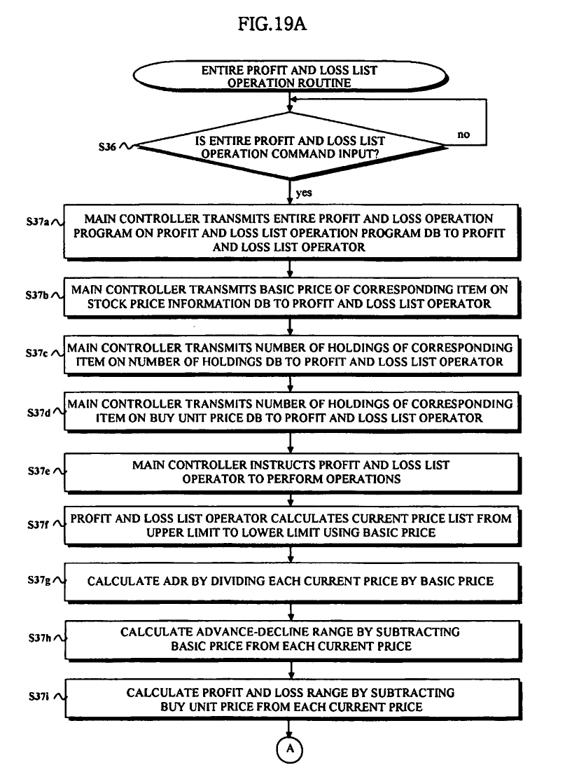

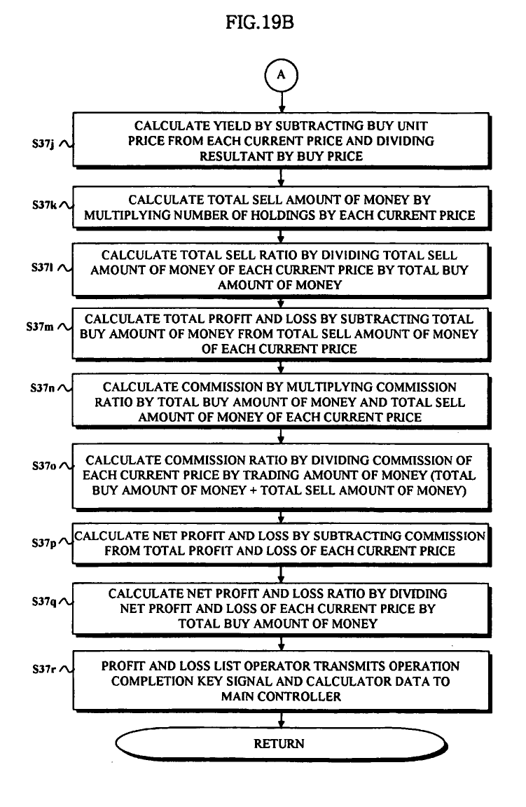

FIGS. 19A and 19B show the entire profit and loss list operation routine (S37). When it is determined in the step S36 that the entire profit and loss list operation command is input, the main controller 110 transmits the entire profit and loss list operation program 170m on the profit and loss list operation program DB 170 to the profit and loss list operator 180 (S37a), transmits the basic price of the corresponding item on the stock price information DB 190 to the profit and loss list operator 180 (S37b), transmits the number of holdings of the corresponding item on the number of holdings DB 140 to the profit and loss list operator 180 (S37c), transmits the buy unit price of the corresponding item on the buy unit price DB 150 to the profit and loss list operator 180 (S37d), and instructs the profit and loss list operator 180 to perform operations (S37e).

The profit and loss list operator 180 calculates the stock price list using the basic price of the corresponding item (S37f); divides each stock price on the stock price list by the basic price, to thus calculate the ADR (S37g); subtracts the basic price from each stock price, to thus calculate the advance-decline range (S37h); subtracts the buy price from the stock price, to thus calculate the profit and loss ratio (S37i); divides the stock price by the buy price, to thus calculate the yield (S37j); multiplies the stock price by the number of holdings, to thus calculate the total sell amount of money (S37k); divides the total sell amount of money by the total buy amount of money, to thus calculate the total sell ratio (S37l); subtracts the total buy amount of money from the total sell amount of money, to thus calculate the total profit and loss (S37m); multiplies the total buy amount of money and the total sell amount of money by the commission ratio, to thus calculate the commission (S37n); divides the commission by the trading amount of money (the total buy amount of money+the total sell amount of money), to thus calculate the commission ratio (S37o); subtracts the commission from the total profit and loss, to thus calculate the net profit and loss (S37p); and divides the net profit and loss by the total buy amount of money, to thus calculate the net profit and loss of each stock price on the stock price list (S37q), according to the operation command from the main controller 110. The profit and loss list operator 180 transmits the operation completion signal and the calculated data to the main controller 110 (S37r).

Processes of operating the stock price and the profit and loss list were described. However, it is effective for synthetically grasping the stock price to enumerate the stock price list, the ADR list, and the advance-decline range list together. Therefore, though omitted in the above operation processes, when the stock price list is calculated using the basic price, the ADR list and the advance-decline range list are always calculated.

The steps of outputting the calculated profit and loss list to the client PC and displaying the profit and loss data on the corresponding quotation according to the change in the quotation after completing the profit and loss list operation is completed will now be described.

When the operation completion signal is transmitted from the profit and loss list operator 180 (S38), the main controller 110 outputs the calculated profit and loss list data to the client PC 200 through the communication controller 120 (S39), and lets the stock price information DB 190 periodically output the data on the quotation of the corresponding item and the number of sell and buys of each quotation periodically input from the Securities Computer Center 400 at intervals of 3 to 5 seconds to the client PC 200 (S40). (The periodic output of the quotation information at the intervals of 3 to 5 seconds is generally used and can be changed if necessary.)

Processes of displaying the profit and loss list data input to the client PC 200 will now be described.

When the profit and loss list data is input from the profit and loss analysis system 100 to the client PC 200 (S41), the CPU 210 of the client PC shows the input profit and loss list data and the profit and loss data corresponding to each quotation on the quotation information window 250c of the sell order screen 250 and on the profit and loss item list window 250e (S42) and displays the entire profit and loss list data on the profit and loss list by quotation window 250f (S43).

The CPU 210 transmits the profit and loss list data to the main memory 230 and lets the main memory 230 temporarily store the profit and loss list data (S44).

Because 10 quotations (5 sell and 5 buys) are commonly shown in the profit and loss list by quotation window 250f, 10 profit and loss data items with respect to the 10 quotations are shown. The entire stock price list from the upper limit to the lower limit and the profit and loss data corresponding to the stock price is displayed.

When the quotation information such as the quotation and the number of sell and buys of each quotation is periodically input from the profit and loss analysis system 100 at intervals of 3 to 5 seconds (S45), the CPU 210 determines whether there is a difference between the quotation (5 sell and 5 buys) within the quotation publication range, which is input from the profit and loss analysis system 100, and the previously input quotation (S46). (For example, the range of the quotation shown in the quotation sell and buy information window 250c increases about 20 won from 10 prices of 7000, 7010, . . . , 7080, and 7090 to 7020, 7030, . . . , 7100, and 7110.)

When it is determined in the step S46 that the quotation publication range does not change, the CPU 210 displays only the data on the quotation and the number of sell and buys currently on the quotation information window 250c (S47) because the quotation does not change.

When it is determined in the step S46 that the quotation publication range does change, the CPU 210 must display the profit and loss data on a newly added quotation. Therefore, the moment the changed quotation and the number of sell and buys of each quotation are displayed on the quotation information window 250c (S48), the profit and loss list data temporarily stored in the main memory 230 is read through the step S44 (S49). The CPU 210 displays the profit and loss data corresponding to the newly added quotation on the profit and loss list by quotation window 250f (S50). Therefore, the user can automatically know his or her profit and loss value with respect to the newly added quotation.

Through the above steps S48, S49, and S50, the user can automatically grasp the stock price information and the profit and loss information without any work by automatically displaying the profit and loss value corresponding to the price when the quotation changes, and accordingly, when the price fluctuates. That is, even though the number of quotations of a specific item is about 260, only 10 quotations are shown in the quotation information window 250c. Therefore, even when the quotation changes, the profit and loss value corresponding to the quotation is automatically shown.

A sell order step will now be described.

When the user desires to input the sell order, the CPU 210 determines whether the user selects (double clicks) a specific quotation in the quotation information window 250c or selects (double clicks) the stock price (a row) of the profit and loss list window 250g in order to grasp the profit and loss at the price that diverges from the quotation publication range and to input the quotation to the sell unit price (S51).

When it is determined that the user selects a specific stock price, the CPU 210 automatically inputs the stock price selected by the user to the sell unit price input blank 250i (S52) and automatically inputs data on the number of holdings of the corresponding item of the holding item information window 250b to the number of sell input blank 250h (S53). Accordingly, the sell unit price and the number of sell required for the sell order are automatically and simultaneously input without keyboard operations.

The CPU 210 highlights the row corresponding to the input sell unit price in the quotation information window 250c and the profit and loss list window 250g so that the user can distinguish the row from the other rows (S54).

The overall calculation window 250j shows the number, the buy price, the sell price, the profit and loss range, the yield, the total buy amount of money, the total sell amount of money, the total profit and loss (ratio), the commission (ratio), and the net profit and loss (ratio), using the stock price selected by the user as the sell price (S55). Accordingly, the user can grasp all of the profit and loss information corresponding to the case where the selected quotation is used as the sell price.

When the sell order is input according to the quotation selected by the user and the user selects an order transmission button according to the final check and determination, the CPU 210 outputs the account number, the trading password, the item code, the item unit price in the sell unit price input blank 250i, and the number of sell data of the number of sell input blank 250h that are required for the sell order from the profit and loss analysis system 100 (S56). Accordingly, the profit and loss analysis system 100 transmits them to the Securities Computer Center 400 so that the sell order is concluded, and outputs the trading conclusion result to the client PC (common processes).

Cases where the sell order transmitted by the user is not concluded or the input order is corrected or canceled will now be described.

After the sell order is input, when the user selects the cancel order button with the right mouse button on the row corresponding to the highlighted sell price in the quotation information window 250c or the profit and loss list window 250g (S57), the CPU 210 cancels the sell order corresponding to the corresponding price (S58).

When the user drags the row corresponding to the highlighted sell price in the quotation information window 250c or the profit and loss list window 250g to another price or selects a new price (S59), the CPU 210 automatically inputs the selected price in the sell unit price input blank 250i. When the user selects a correction order button, the CPU 210 executes a sell correcting order using the newly selected price as a correction unit price (S60).

The user can easily order buys or sell while looking at the information on profit and loss related to investment through the above processes.

A case where all of the profit and loss list operations are performed on the cyber trading system of the client PC 200, which is a modification of the first embodiment where the profit and loss list operations are performed by the profit and loss analysis system 100 of the securities company, will now be described as a second embodiment.

In the second embodiment, the profit and loss list operations are not performed on the profit and loss analysis system 100 of the securities company, but on the cyber trading system of the client PC 200.

The elements required for profit and loss list operation are the profit and loss list operation program and the input variable such as the basic price, the buy price, and the number. The profit and loss list operation program is stored in the cyber trading program storage unit 240 of the client PC 200. The related data value of the holding item information window 250b of the sell order screen 250 is used as the input variable such as the basic price, the sell price, and the number.

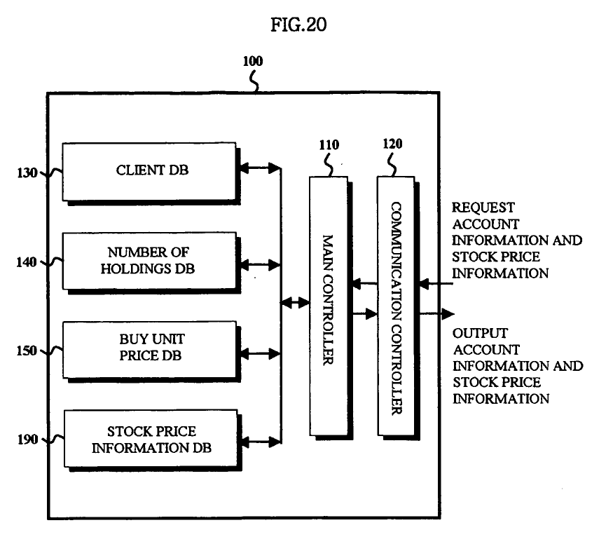

FIG. 20 shows a structure of the profit and loss analysis system 100 according to the second embodiment of the present invention.

FIG. 20 corresponds to a system providing the account information and the stock price information used by the securities company.

Referring to FIG. 20, the profit and loss analysis system 100 includes the main controller 110, the communication controller 120, the client DB 130, the number of holdings DB 140, the buy unit price DB 150, and the stock price information DB 190.

The communication controller 120 of the profit and loss analysis system 100 performs wire and wireless communication related to the profit and loss list between the plurality of client PCs 200(1), . . . and 200(N) and the profit and loss analysis system 100. The communication controller 120 outputs data on the name of the holding item, the number of holdings, the buy unit price, and the stock price information of the corresponding user to the corresponding client PCs 200(1), . . . and 200(N) through the network communication network 300.

The main controller 110 periodically outputs the corresponding data on the number of holdings DB 140, the buy unit price DB 150, and the stock price information DB 190 to the corresponding client PCs 200(1), . . . and 200(N).

The client DB 130 provides data required for determining whether the user is a legal user during login.

The number of holdings DB 140 stores data on the number of holdings of the stocks of the user and transmits data on the number of holdings of each item to the client PC according to the instruction of the main controller 110.

The buy unit price DB 150 stores data on the buy unit price of the user and transmits data on the buy unit price of each item to the client PC according to the instruction of the main controller 110.

The stock price information DB 190 stores the stock price information such as the basic price, the current price, the quotation, the number of sell at each quotation, the number of buys, the trading amount, and the upper and lower limits of the corresponding item, which is input from the Securities Computer Center 400. The stock price information DB 190 periodically outputs information on the basic price and other stock prices of the corresponding item, and information on the quotation and the number of sell and buys of each quotation, which is periodically input from the Securities Computer Center, to the client PC.

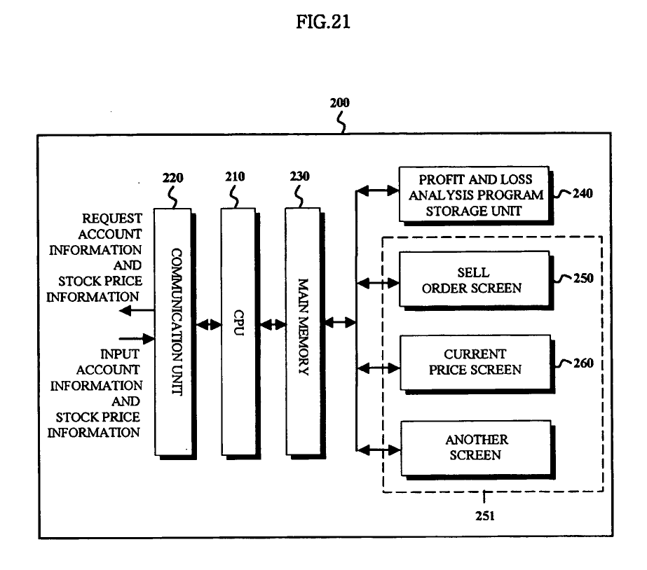

FIG. 21 shows a structure of the cyber trading system 200 in the client PC according to the second embodiment of the present invention.

The cyber trading system 200 in the client PC includes the CPU 210, the communication unit 220, the main memory 230, the profit and loss analysis program storage unit 240, the sell order screen 250, and a current price screen 260.

The communication unit 220 performs wire and wireless communications related to the account information and the stock price information between the client PC and the profit and loss analysis system 100. The communication unit 220 receives data on the name of the holding item, the basic price, the number of holdings, and the buy unit price according to the selection of an account information inquiry button of the user, periodically receives the stock price information (the quotation and the number of sell and buys) of the corresponding item, and transmits the data and the stock price information to the CPU 210.

The CPU 210 requests the account information from the profit and loss analysis system 100 and controls reception of the account information (1), displays periodically input data on the quotation and the number of sell and buys of each quotation of the corresponding item (2), calculates the profit and loss list according to the request for the profit and loss list operations by the user (3), displays the profit and loss list data (4), stores the main memory of the profit and loss list data (5), and executes the sell order (6).

The main memory 230 temporarily stores the corresponding program and the profit and loss list data of the cyber trading program storage unit 240 according to the control of the CPU 210.

The profit and loss analysis program storage unit 240 stores various programs for operating the profit and loss list, which are automatically downloaded from the profit and loss analysis system 100 after login. The programs do not frequently change unless the quotation unit, the upper and lower ranges, and the commission ratio change. Therefore, when the programs are initially downloaded, it is not necessary to download the programs whenever the user accesses the profit and loss analysis system 100.

The sell order screen 250 displays the quotation information and the profit and loss list information of the corresponding item according to the control of the CPU 210 and outputs data on the number of sell and the sell unit price, which is input by the user in order to sell stocks, to the profit and loss analysis system 100.

The current price screen 260 displays information on the stock price of the corresponding item, the quotation and the number of sell and buys of each quotation, and information on the profit and loss of each quotation according to the control of the CPU 210.

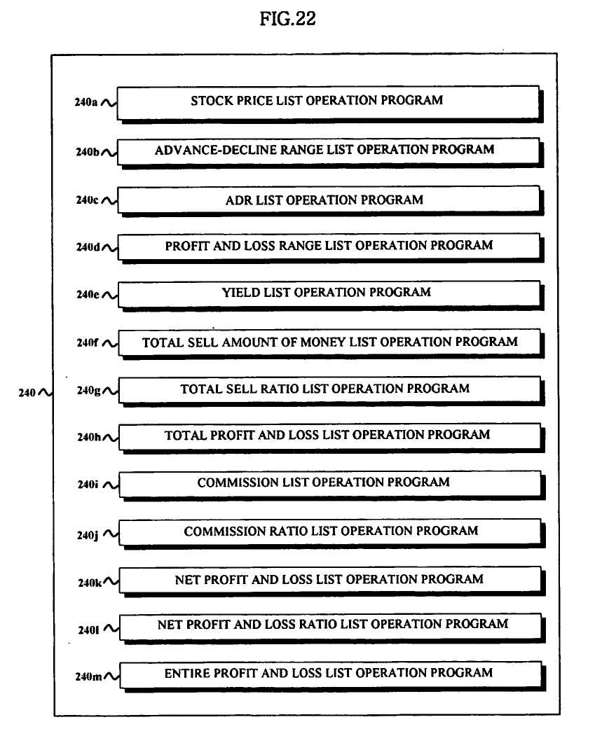

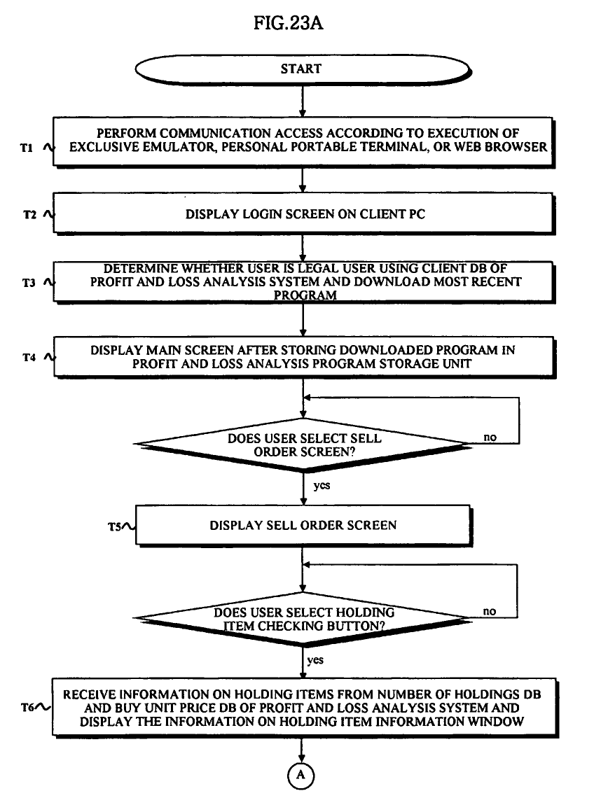

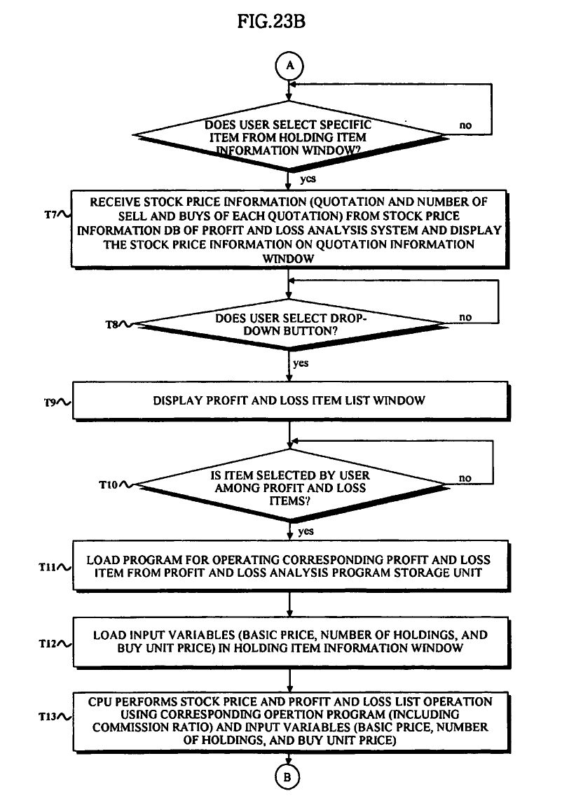

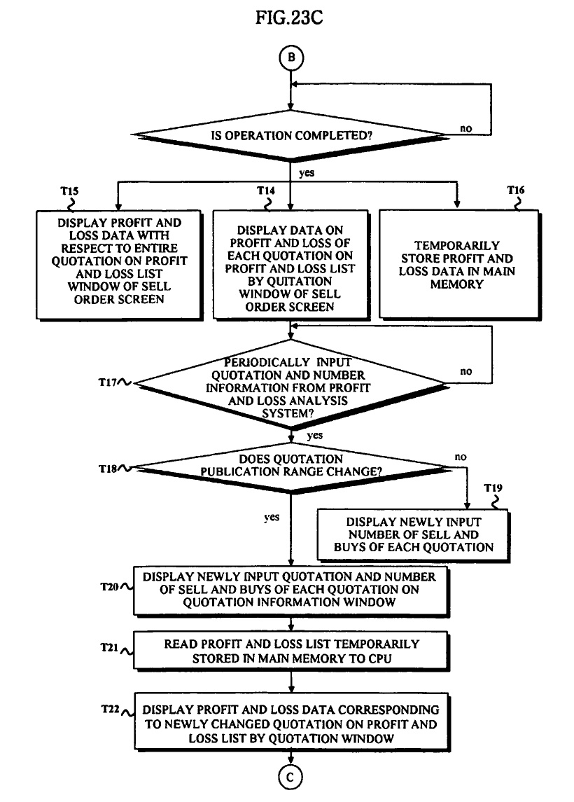

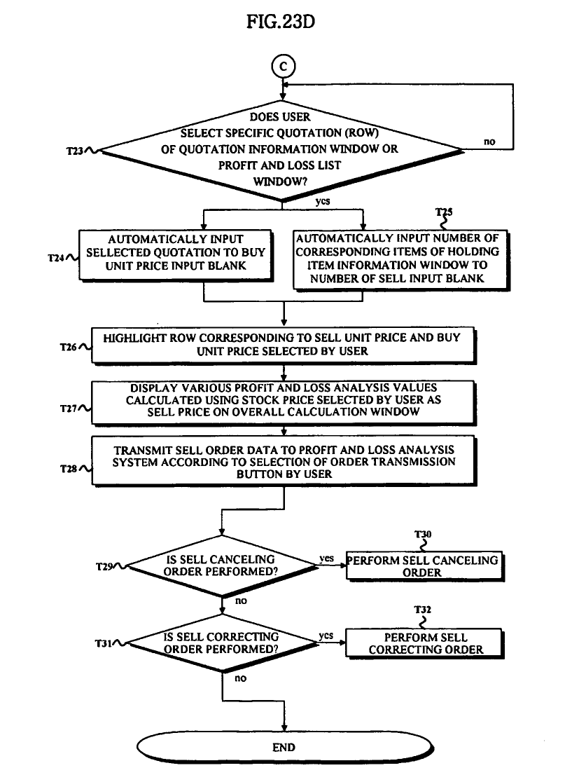

FIG. 22 shows a structure of the profit and loss analysis program storage unit 240 according to the second embodiment of the present invention. The programs of the profit and loss analysis program storage unit 240 are the same as the various operation programs 170a through 170m of the profit and loss list operation program DB 170 according to the first embodiment.

The profit and loss analysis program storage unit 240 includes the following 13 operation programs, that is, a stock price list operation program 240a, an ADR list operation program 240b, an advance-decline range list operation program 240c, a profit and loss range list operation program 240d, a yield list operation program 240e, a total sell amount of money list operation program 240f, a total sell ratio list operation program 240g, a total profit and loss list operation program 240h, a commission list operation program 240i, a commission ratio list operation program 240j, a net profit and loss list operation program 240k, a net profit and loss ratio list operation program 240l, and an entire profit and loss list operation program 240m.

The operations of the respective operation programs on the profit and loss list operation program DB 170 are the same as those of the first embodiment. Therefore, description of the operation processes of the respective programs will be omitted.

The profit and loss list operation processes of the cyber trading service apparatus according to the second embodiment of the above structure will now be described.

The client PC 200 accesses the profit and loss analysis system 100 of each Securities company through the network communication network 300 (T1).

The client PC 200 receives user login screen data and displays the data on the main screen (T2).

The client PC 200 outputs the ID input by the user and the login data of the password to the profit and loss analysis system 100. The profit and loss analysis system 100 outputs the main screen of the most recent cyber trading program to the client PC when the user is a legal user (T3).

The CPU 210 of the client PC 200 stores a newly downloaded profit and loss analysis program in the profit and loss analysis program storage unit 240 and displays the main screen (T4).

When the user selects the sell order screen 250 on the client PC 200, the CPU 210 displays the sell order screen 250 (T5).

When the user selects the holding item checking button 250a on the sell order screen 250, the CPU 210 outputs a holding item checking signal to the profit and loss analysis system 100, receives information on the holding items from the number of holdings DB 140, the buy unit price DB 150, and the stock price information DB 190 of the profit and loss analysis system 100; and displays data such as the name of the item, the basic price, the buy unit price, and the number of holdings on the holding item information window 250b (T6).

When the user selects a specific item among the holding items displayed on the holding item information window 250b, the CPU 210 periodically receives the stock price information of the corresponding item such as data on the quotation and the number of sell and buys of each quotation from the profit and loss analysis system 100, and displays the stock price information on the quotation information window 250c (T7).

Because the above processes T1 through T7 are well known, detailed description thereof will be omitted.

Through the above processes T1 through T7, the cyber trading system of the client PC 200 secures the profit and loss list operation programs (including the commission ratio) for operating various profit and loss lists and input variables such as the basic price, the buy price, and the number of holdings.

Processes of operating various profit and loss lists on the cyber trading system of the client PC 200 will now be described.

When the user selects the drop-down button 250d in order to know the profit and loss list of the corresponding item in a state where the quotation information is periodically displayed on the quotation information window 250c (T8), the CPU 210 displays the profit and loss item list window 250e (T9).

When the user selects a specific item among the profit and loss items displayed on the profit and loss item list window 250e (T10), the CPU 210 loads the corresponding profit and loss list operation program from the cyber trading program storage unit 240 (T11) and loads the input variable data of the corresponding item such as the basic price, the buy unit price, and the number of holdings in the holding item information window 250b (T12).

The CPU 210 performs operations using the profit and loss list operation programs and the input variable data such as the basic price, the buy unit price, and the number of holdings, which are input through the above processes T11 and T12 (T13).

The operations proceed in the same way as the operations performed by the profit and loss list operator 180 of the profit and loss analysis system 100 as described in the first embodiment (Because the operation routines of each profit and loss item are described in S12, S14, S16, S18, S20, S22, S24, S26, S28, S30, S32, and S34, detailed description thereof will be omitted.)

Steps of displaying the calculated profit and loss list data proceed in the same way as the first embodiment.

When the operations are completed, the CPU 210 displays the profit and loss data corresponding to the quotation currently displayed on the quotation information window 250c on the profit and loss list by quotation window 250f (T14) and displays the entire profit and loss list data on the profit and loss list window 250g (T15).

The CPU 210 transmits the calculated profit and loss list data to the main memory 230 and lets the main memory 230 temporarily store the calculated profit and loss list data (T16).

When the quotation information such as the quotation and the number of sell and buys of each quotation is periodically input from the profit and loss analysis system 100 at intervals of 3 to 5 seconds (T17), the CPU 210 determines whether there is a difference between the quotation (5 sell and 5 buys) within the quotation publication range, which is input to the profit and loss analysis system 100, and the previously input quotation (T18).

When it is determined in the step T18 that the quotation publication range does not change, the quotation does not change. Therefore, the CPU 210 does not have to display the changed profit and loss data. Accordingly, only data on the quotation and the number of sell and buys is displayed on the quotation information window 250c (T19).

When it is determined in the step T18 that the quotation publication range changes, the CPU 210 must display the profit and loss data on the newly added quotation. Therefore, the CPU 210 displays the changed quotation and the changed number of sell and buys of each quotation on the quotation information window 250c (T20) and reads the profit and loss list data temporarily stored in the main memory 230 through the step T16 (T21).

The CPU 210 displays the profit and loss data corresponding to the newly added quotation on the profit and loss list by quotation window 250f (T22).

Processes of a sell order, a correction order, and a canceling order will now be described. The orders related to sell such as the sell order, the correction order, and the canceling order proceed in the same way as the above steps S51 through S60 of the first embodiment (T23 through T32). (Because detailed description of the orders related to sell is the same as the first embodiment, the detailed description thereof will be omitted.)

Several materials and operation results applied to the embodiment of the present invention will now be described.

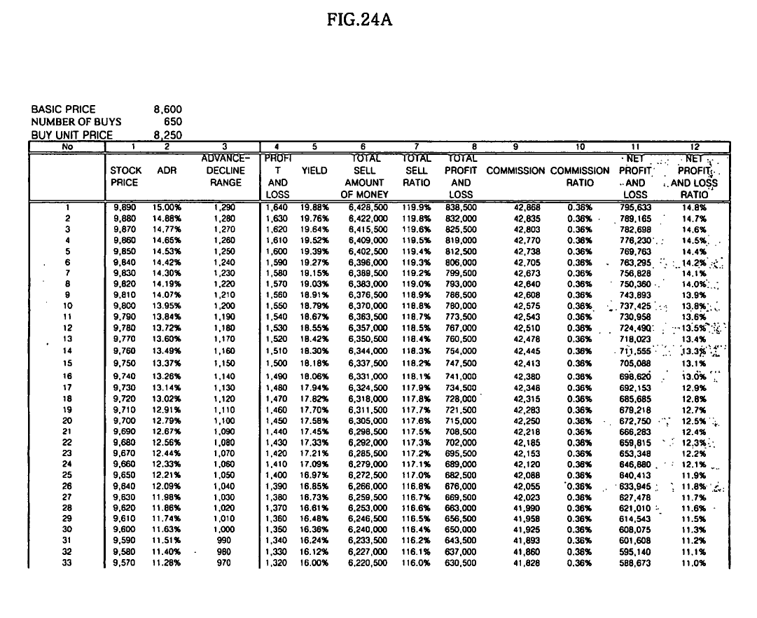

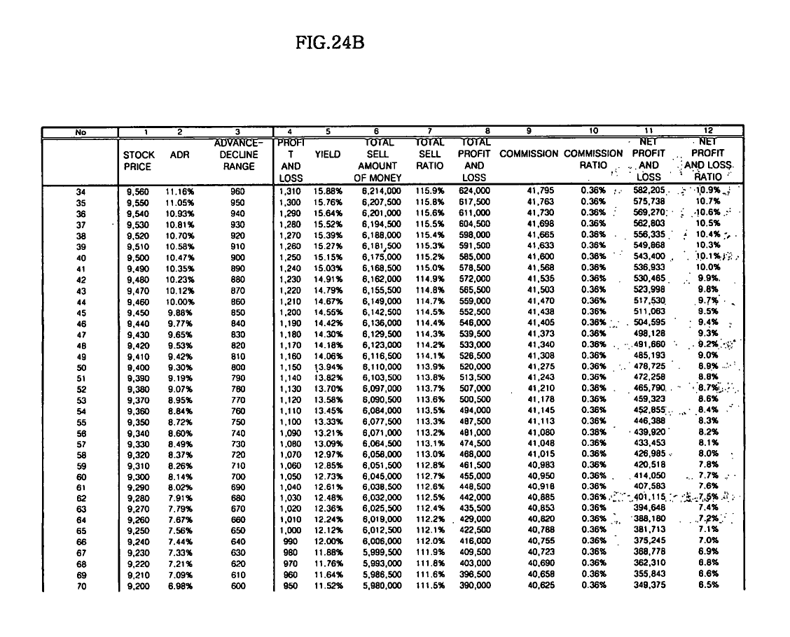

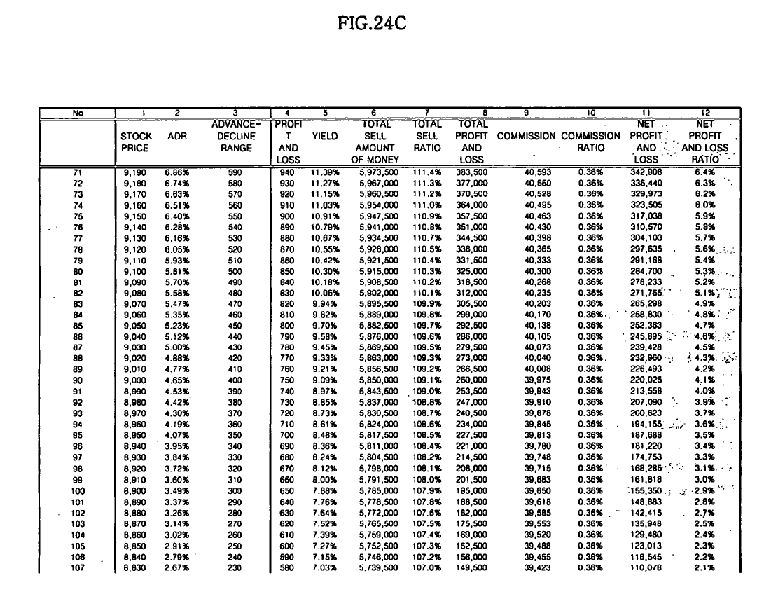

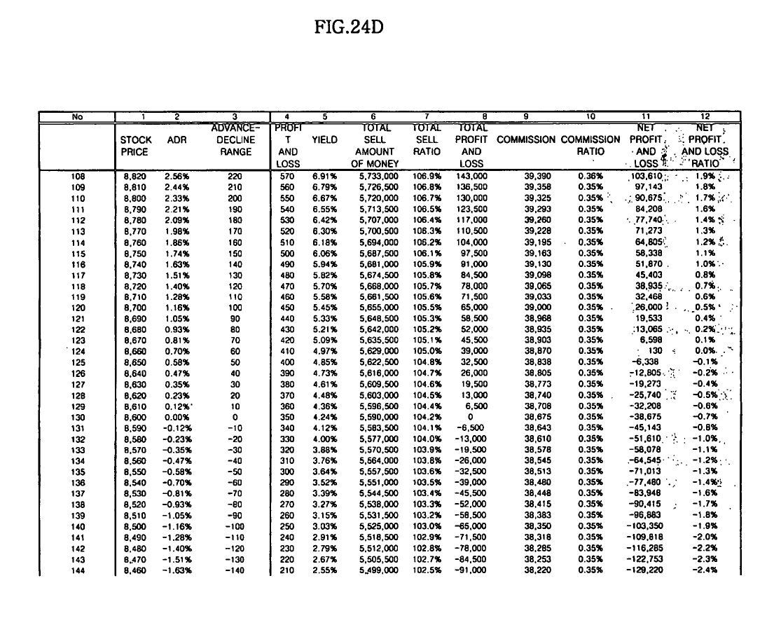

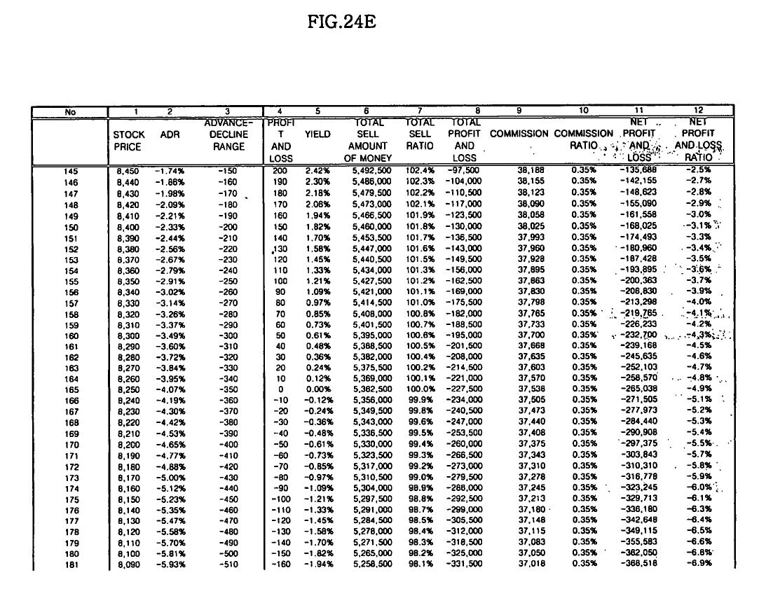

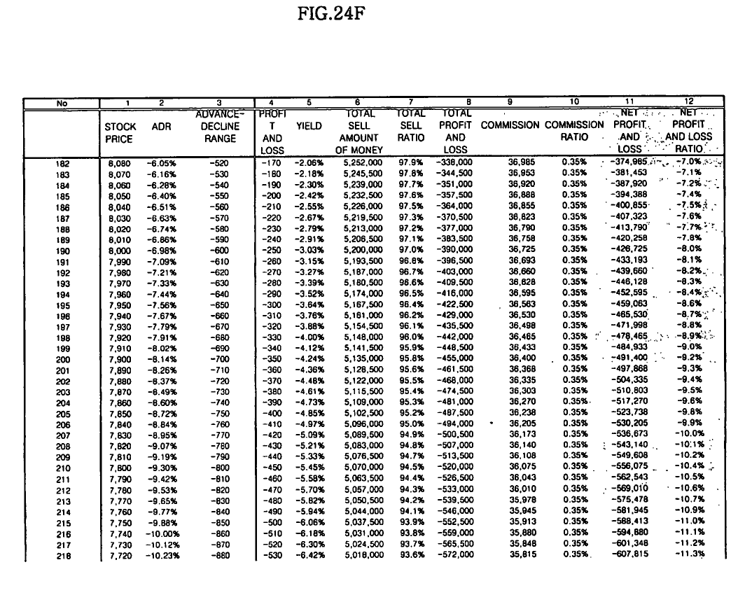

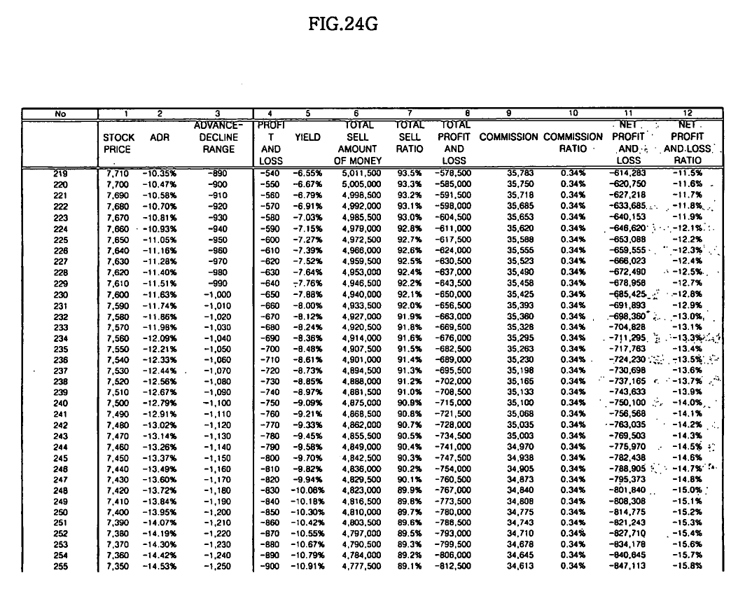

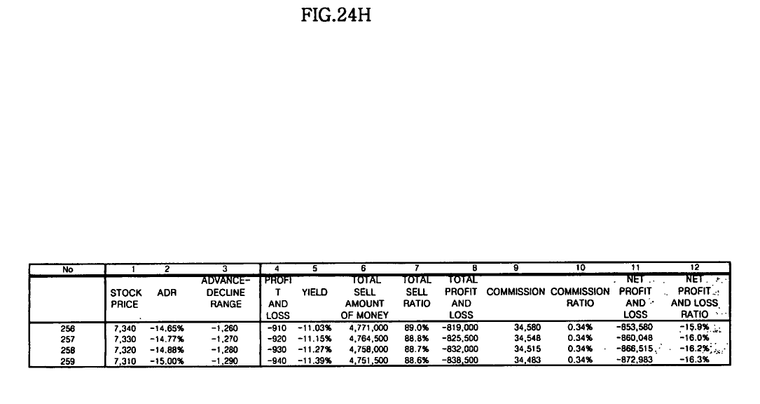

FIGS. 24A through 24H show an example of the entire profit and loss list calculated by the cyber trading system of the client PC 200. The number of calculation items is 12. That is, the number of stock price items is 3 and the number of profit and loss items is 9. The number of stock prices is 260, and the number of total data items is 3,120 (12 columns×260 row). Time spent on the operations on the client PC according to the second embodiment is about 0.1 second. The data can be edited and displayed by various methods according to screen characteristics, such as by the current price and the sell order screen or as requested by the user. For example, a specific column or only a specific region of data can be displayed according to the request of the user.

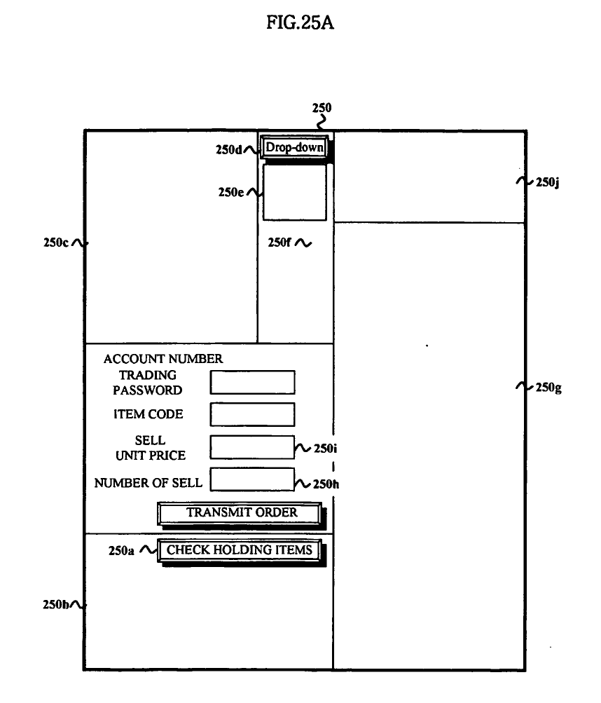

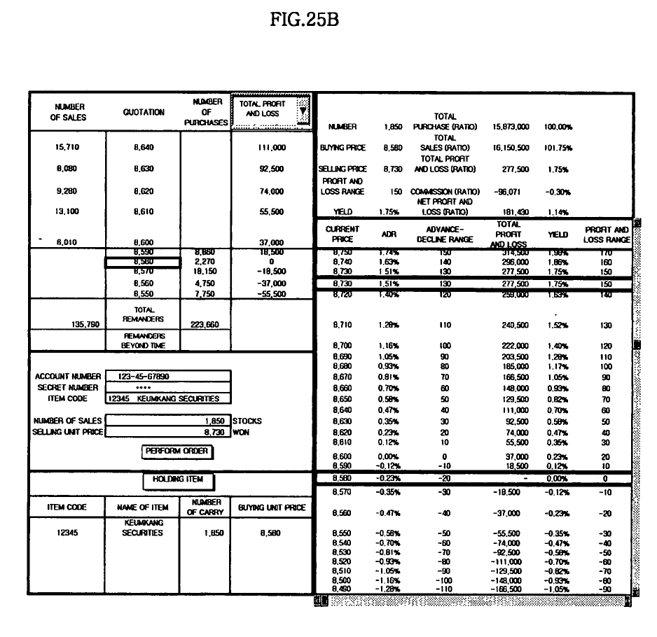

FIGS. 25A and 25B show the sell order screen 250 according to the present invention where the account information, the quotation information, and the profit and loss analysis information are intensively displayed. For example, after an investor buys 1,850 Keumkang securities at 8,580 won, he or she can grasp the stock price list and a change in his or her profit and loss at each price through the quotation information window 250c and the profit and loss list window 250g.

When the investor double clicks 8,730 won of the profit and loss list window 250g in order to make a decision and to sell stocks after synthetically determining the stock prices and the change in the profit and loss, the number of sell 250i and the sell unit price 250h are automatically input and the sell order is transmitted.

The buy price (8,580 won) and the sell price (8,730 won) are highlighted on the profit and loss list window 250g. Accordingly, it is possible to visually grasp the distance (the profit and loss range) between the buy price and the sell price. When the sell price is input or changed, various profit and loss resultant values are synthetically displayed on the overall calculation window 250j so that the investor can intensively determine the profit and loss items.

The profit and loss column such as the total profit and loss and the commission of the profit and loss list window 250g can be increased, reduced, and arranged according to the selection of the investor.

During the correction order, when the investor double clicks a corrected price 8,700 won or drags the highlighted sell price 8,730 by a mouse to the corrected price 8,700 won, 8,700 won is input in the sell unit price input blank 250i. Accordingly, the correction order is performed.

During the canceling order, the cancellation command is selected with the right mouse button on the row where the 8,730 won highlighted as the sell price is positioned.

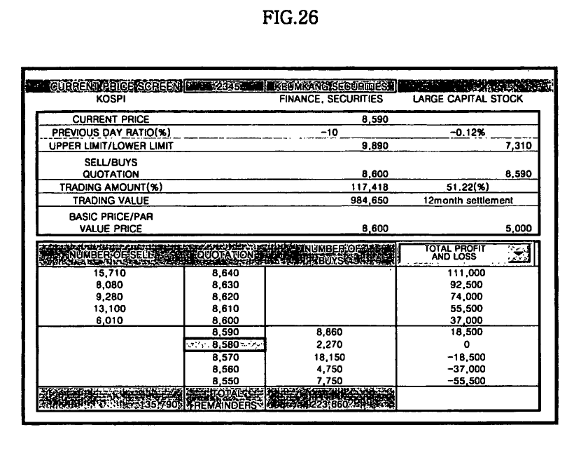

FIG. 26 shows the drop-down button 250d and the profit and loss list by quotation window 250f attached to the current price screen 260. The current price screen is most frequently looked at by the investor because the current price screen provides the most information on the corresponding item. However, only the stock price information exists and the profit and loss information does not exist on the conventional current price screen. Therefore, the investor must alternately inquire of the current price screen and the account information screen in order to grasp the profit and loss. During inquiring about the profit and loss, the Securities company server provides the total profit and loss and the yield based on the current price and it takes a long time to perform the communication and operation.

Because the stock price information and the profit and loss information are combined with each other and are displayed on the improved current price screen according to the present invention, the investor can grasp 3 core information items in one place, that is, (1) the published quotation, (2) the actual change in the number of sell and buys at each quotation, and (3) various profit and loss analyses of each quotation. Therefore, the investor can obtain combined core information because it is possible to simultaneously determine the stock price and the profit and loss in real time. Accordingly, the investor can maximize his or her profit by realizing appropriate profit or by resolutely performing sell with a loss.

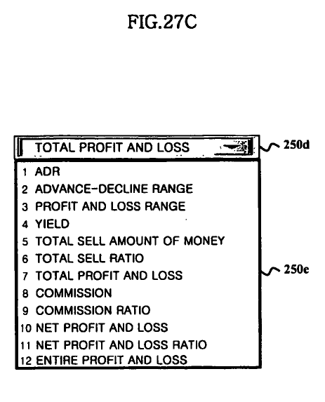

FIG. 27 shows an example of a profit and loss item list window 250e displayed according to the selection of the drop-down button 250d. When the investor selects the drop-down button in order to select the profit and loss items in which he or she is interested, various profit and loss item lists such as the ADR, the advance-decline range, and the total profit and loss are enumerated. When the entire profit and loss is selected, it is possible to know all of the items such as the stock price and the profit and loss. All of the profits and losses at all of the prices as shown in FIGS. 24A through 25D are provided to the investor.

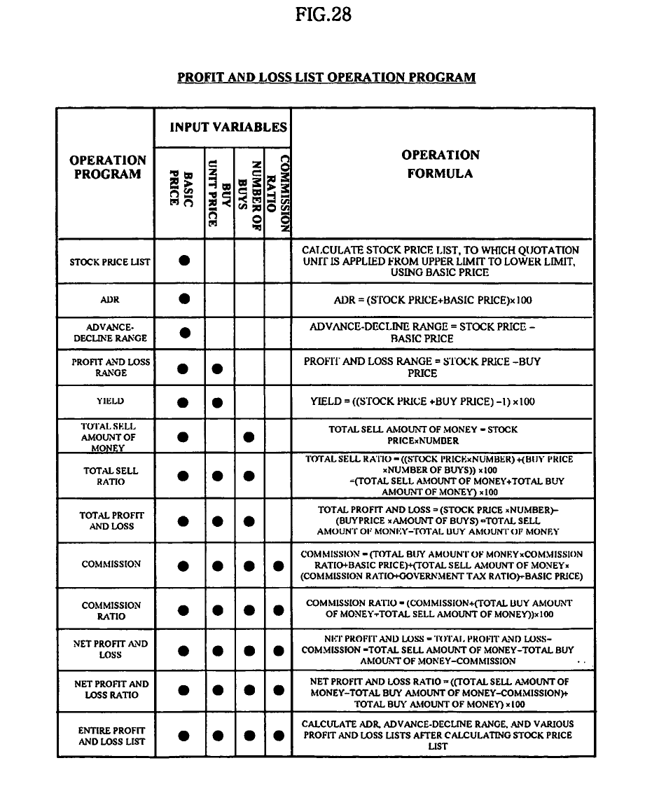

FIG. 28 shows the input variables and the operation formulas of the profit and loss analysis programs 170a through 170m and 240a through 240m. The principle of the present invention is that all of the stock prices such as the quotation, the ADR, and the advance-decline range are calculated and that all of the profits and losses can be calculated using three input variables, that is, the buy unit price, the number of buys, and the commission ratio. The basic price is basically used in all of the calculations. The buy unit price and the number of buys are basically required for analyzing the profit and loss.

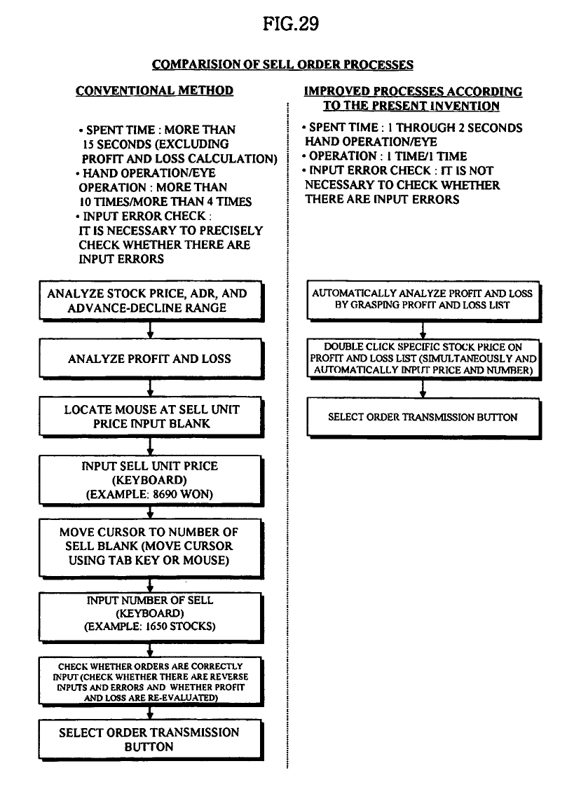

FIG. 29 allows comparison between a conventional sell order method and an improved sell order according to the present invention. According to the present invention, the sell unit price and number are automatically and simultaneously input by the investor clicking the mouse once. There is no possibility that the sell unit price and the number are inversely input or that wrong inputs are performed. It is not necessary to check whether inputs are correctly performed, so operations of eyes and hands are minimized, as are total operations and time because a keyboard is not used.

The investor can complete an order by only selecting a desired sell price with the mouse after analyzing the stock price and the profit and loss on the profit and loss list. The correction order and the canceling order are performed by operating the mouse once.

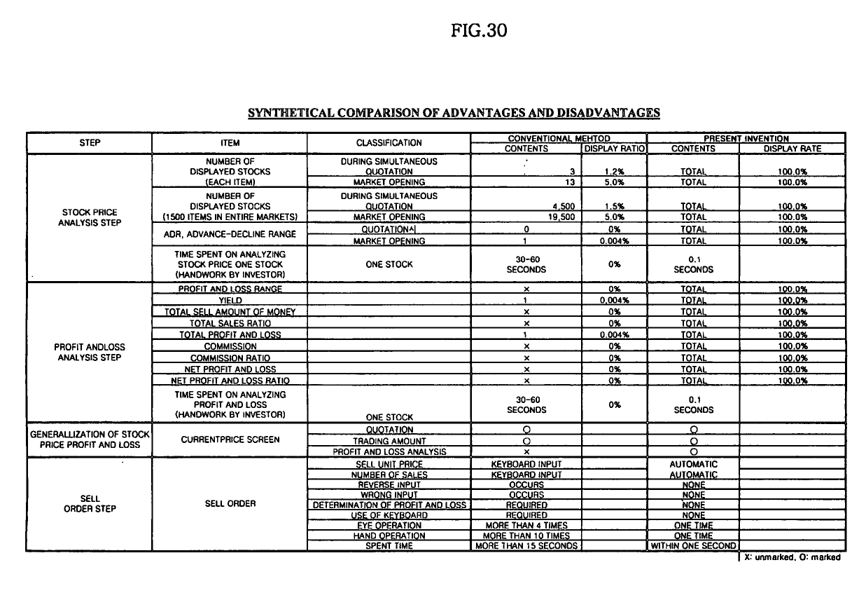

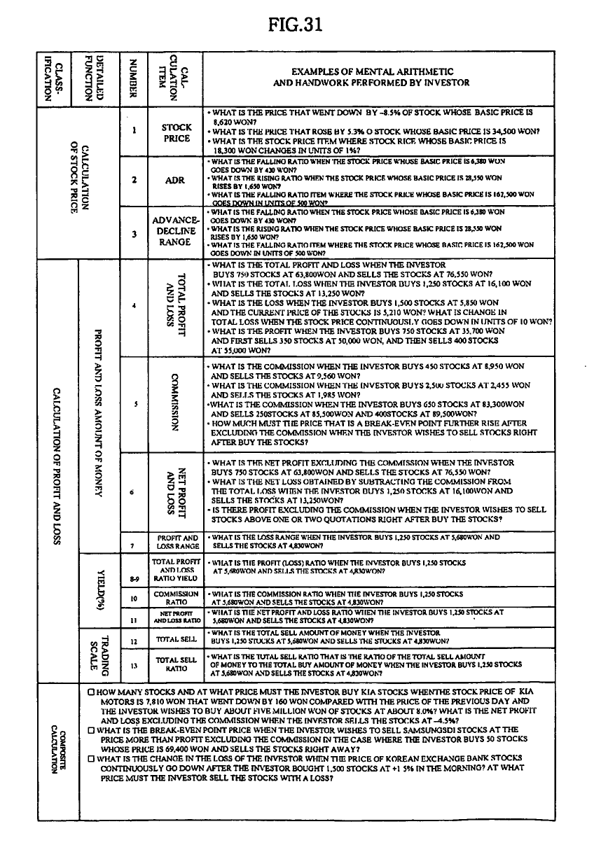

FIG. 30 allows comparison between a conventional cyber trading method and a profit and loss analysis system according to the present invention. According to the present invention, processes of the profit and loss analysis and the sell order, which are performed by the investor in each step of the cycle of the buy step→the stock price analysis step→the profit and loss analysis step→the sell decision making step→the sell order step→the end of the stock trading, are improved. That is, because all of the prices and all of the profit and loss information are quickly and correctly provided to the investor, the investor does not have to perform calculations and inputs. Also, the investor can circulate through the entire process of the stock trading cycle within several seconds.

As mentioned above, the cyber trading service apparatus and method according to the embodiment of the present invention have the following effects.

1) The investor can know all of the stock prices that occur on the day with respect to all of the items such as stocks, futures, and options, the ADR of each stock price, and the advance-decline range list, and various profits and losses at each price in the form of a table by only clicking the mouse once.

2) Automatic ordering—The investor can automatically and simultaneously input the sell price and the number of sell by only clicking the mouse once during the sell order. When the investor selects a specific price on the profit and loss list, the sell price and the number of sell are simultaneously and automatically input.

3) Automatic correction and cancellation orders—The investor can perform the sell correcting order or the canceling order by only clicking the mouse once.

4) The improvement of orders—It took more than 10 seconds to perform the sell order in the conventional technology. However, it takes only one second to perform the sell order according to the present invention. Undesired losses can be prevented because the sell price and the number of sell are not inversely input. There is no incorrectly input data on the sell price and the number of sell. More than 10 keyboard inputs are not required for inputting the prices and the number. The investor must alternately look at the monitor and the keyboard more than 4 times in the conventional technology, but the investor only has to look at the monitor according to the present invention. The investor does not have to check whether the number of sell and the sell unit price are correctly input after inputting the order and before transmitting the order, nor do they have to analyze the profit and loss generated after inputting the order. The investor also does not have to alternately use the keyboard and the mouse in order to input numbers.

5) The synergy effect—The investor can simultaneously grasp 3 core information items, that is, the quotation, the number of sell and buys of each quotation, and various profit and loss analyses of each quotation, in the quotation information window. Accordingly, the investor can rapidly and effectively make a trading decision.

6) Two dimensional calculation—The profit and loss can be inquired about at only one price (a cell unit) based on the current price in the conventional technology. However, all of data of a two dimensional area can be calculated at all of the prices, according to the present invention.

7) Intensive data expression—The investor can intensively grasp a large amount of data because the stock price and the profit and loss analysis materials are expressed in the form of a table. Because the stock price, the ADR, and the advance-decline list can be simultaneously and visually compared with each other and analyzed, the investor can synthetically determine the stock price according to the synergy effect. The investor can know only the total profit and loss and the yield in the conventional technology, but they can analyze the profit and loss with respect to all of the 9 profit and loss items with the present invention.

8) Reduction in time and expenses—The investor can save energy spent on analyzing the stock price and the profit and loss. Because time spent on calculating the stock price, analyzing the profit and loss, and performing the sell order is reduced, more than two hundred billion won can be saved on the basis of one year.

9) Support of making a sale with a loss decision—The investor can effectively make a trading decision because the investor can synthetically determine the states of the profits and losses at each price. In the case of a loss, the investor can minimize the loss by resolutely performing the sale with a loss because the investor can visually grasp the increase in the loss at each price.

10) The investor can grasp the stock price and the profit and loss on one screen without alternately inquiring about the current price screen and the account information screen. The investor does not have to access the account information screen in order to analyze the profit and loss.

11) It is not necessary for the investor to have a memo pad, writing materials, and an electronic calculator in front of the monitor. The investor can effectively analyze the stock price and the profit and loss by previously outputting a profit and loss list data and attaching it on the monitor.

12) When the calculator is used, the investor can analyze the profit and loss at a price of a long term that deviates from the current stock price change range (when the today basic price is 1,000 won, and the hereafter-basic price is input as 2,500 won.)

13) The investor does not have to input the sell price for analyzing the profit and loss. Each stock price on the stock price list is assumed to be the sell price. The resultant value is the same when each stock price is input as the sell price.

14) All of the stock prices from the upper limit to the lower limit that can occur on the data, the ADR of each stock price, and the advance-decline range list are calculated only with the basic price. The profit and loss analysis of each stock price is calculated using the 4 variables: the basic price, the buy price, the number of buys, and the commission ratio.

15) Grasp of a break-even point—Because the day trader can visually grasp the break-even point on the sell order screen and the current price screen, the day trader can grasp a clearer sell basic point. Accordingly, the day trader can maximize his or her profit.

16) It is necessary and effective to analyze the stock price and the profit and loss because the ADR and the trading profit and loss of futures and options are much larger than those of the stocks.

17) The securities company can provide better services to clients. In particular, because the workers of the securities company and the securities experts can provide faster and more various services to the clients, the securities company can satisfy the clients more. Also, the investor of the branch of the Securities company can output the stock price and the profit and loss list without visiting the terminal in order to inquire of the balance, to thus grasp the profit and loss.

While this invention has been particularly shown and described with reference to preferred embodiments thereof, it will be understood by those skilled in the art that various changes in form and details may be made therein without departing from the spirit and scope of the invention, wherein the investor can grasp all of the stock price lists existing in the stock market and various profits and losses of each stock price within one second by clicking the mouse once, and the order is automatically performed, as defined by the appended claims.

What is claimed is:

1. A cyber trading service apparatus for providing a cyber trading service according to requests of a plurality of client personal computers (PCs), the cyber trading service apparatus comprising:
a main controller for operating a profit and loss list and outputting operation result data when an operation request signal with respect to a profit and loss list is received from a corresponding client PC; and
a profit and loss list operator for operating the profit and loss list from the basic price, the number of holdings, the buy unit price, and the commission ratio of a corresponding item and outputting the operation result to the corresponding client PC when the account number, the item code, and the profit and loss item code of a user are input through the main controller.

2. The cyber trading service apparatus of claim 1, further comprising a communication controller for transmitting an operation performance key signal, the account number, the item code, and the profit and loss item code to the main controller and outputting the calculated profit and loss list to the corresponding client PC through a network communication network according to control of the main controller when the operation performance key signal, the account number, the item code, and the profit and loss item code are input from the client PC according to the selection of a drop-down button by each user.

3. The cyber trading service apparatus of claim 1 or 2, further comprising:
a client database (DB) for storing a user ID, a password, account information, and personal information, and providing the stored data so as to determine whether a client PC user is a legal user during login for performing cyber trading;
a number of holdings DB for storing data on the number of stocks held by the user;
a buy unit price DB for storing data on the buy price (a buy unit price of each stock) of the user; and
a stock price information DB for storing stock price information items such as the basic price, the current price, the quotation, the number of sell at each quotation, the number of buys, the trading amount, and the upper and lower limits of the corresponding item periodically input from the Securities Computer Center.

4. The cyber trading service apparatus of claim 2, further comprising:
an operation program input unit for receiving a plurality of profit and loss list operation programs for operating the profit and loss list together with various operation programs related to cyber securities trading, which are used by the main controller by the profit and loss analysis system manager;
a profit and loss list operation program DB for storing the profit and loss list operation program input from the operation program input unit; and
a profit and loss list operator for operating the profit and loss list using the operation program and the basic price, the number of holdings, the buy unit price, and the commission ratio of the corresponding item according to the control of the main controller.

5. The cyber trading service apparatus of claim 4, wherein the profit and loss list operation program DB comprises:
a stock price list operation program for operating a stock price list, to which a quotation unit is applied from the upper limit to the lower limit, using the basic price of the corresponding item;
an advance-decline ratio (ADR) list operation program for calculating the ADR with respect to each stock price on the stock price list of the corresponding item;
an advance-decline range list operation program for calculating an advance-decline range with respect to each stock price on the stock price list; and
a profit and loss range list operation program for calculating the profit and loss amount of money of each stock with respect to each stock price on the stock price list;
a yield list operation program for calculating a ratio of a sell unit price to a buy unit price with respect to a specific stock price on the stock price list;
a total sell amount of money list operation program for calculating the sell amount of money with respect to each stock price on the stock price list;
a total sell ratio list operation program for calculating a ratio of a sell amount of money to a buy amount of money with respect to each stock price on the stock price list;
a total profit and loss list operation program for calculating the loss or the profit with respect to each stock price on a current price list;
a commission list operation program for calculating the commission with respect to each stock price on the stock price list;
a commission ratio list operation program for calculating a ratio of the commission to the trading amount of money with respect to each stock price on the stock price list;
a net profit and loss list operation program for calculating the net profit and loss with respect to each stock price on the stock price list;
a net profit and loss ratio list operation program for calculating a ratio of the net profit and loss to the buy amount of money with respect to each stock price on the stock price list; and
an entire profit and loss list operation program for calculating all the profit and loss items with respect to each stock price on the stock price list.

6. The cyber trading service apparatus of claim 1, wherein the client PC outputs the account number, the item code, and the profit and loss item code of the user to the outside; receives the profit and loss list operation result from the outside; and displays the profit and loss list operation result on the sell order screen, when the corresponding user selects the profit and loss item in the drop-down button on the sell order screen of the cyber trading system, and the client PC simultaneously inputs a selected price and the number of holdings to the sell price input blank of the sell order and the number of buys blank so that the sell order is performed when the user selects a specific price among the profit and loss lists.

7. A cyber trading service apparatus for receiving securities information from the server of a securities company and providing a cyber trading service, the cyber trading service apparatus comprising:
a profit and loss analysis program storage unit for calculating a profit and loss list of each stock price with respect to a sell stock price and a buy stock price from the basic price, the number of holdings, the buy unit price, and the commission ratio of the corresponding item;
a main memory for temporarily storing data;
a central processing unit (CPU) for loading a corresponding program of the profit and loss analysis program storage unit in the main memory, executing the corresponding program, and outputting an operation result with respect to a profit and loss list when an operation request signal with respect to the profit and loss list is input from a user; and
a display for displaying the operation result output through the CPU to the user.

8. The cyber trading service apparatus of claim 7, wherein the CPU receives the basic price, the number of holdings, the buy unit price, and the commission ratio from the server of the securities company, and calculates the profit and loss list according to the selection of the corresponding item and the drop-down button by the user.

9. The cyber trading service apparatus of claim 7, wherein the CPU displays a profit and loss list by quotation window on a sell order screen on the display.

10. A cyber trading service method providing a cyber trading service according to requests of a plurality of client PCs, the cyber trading service method comprising:
transmitting current price information when a user accesses a cyber trading system of a client PC and selects a sell order screen; and
receiving the account number, the item code, and the profit and loss item code of the user from the client PC, inputting the basic price, the number of holdings, the buy unit price, and the commission ratio of a corresponding item to a previously set operation program, operating a profit and loss list, and outputting the operation result to a corresponding client PC.

11. The cyber trading service method of claim 10, wherein the client PC displays the stock price selected by the user from the profit and loss list result on a sell unit price input blank as a sell price, displays the number of holdings on the number of sell input blank, and transmits sell order data according to the selection of an order transmission button.

12. A cyber trading service method receiving securities information from the server of a securities company and providing a cyber trading service, the cyber trading service comprising:
(a) a CPU displaying a sell order screen when a user logs into a cyber trading system of a client PC;
(b) the CPU receiving stock price information on a holding item from the securities server and displaying the stock price information on a quotation information window when the user selects a holding item button on the sell order screen;
(c) the CPU operating a stock price and a profit and loss list corresponding to the stock price using a corresponding operation program and displaying the stock price and the profit and loss list on a profit and loss list window when the user selects the profit and loss item of the profit and loss list with a drop-down button; and
(d) displaying a profit and loss analysis value using the selected stock price as a sell price and simultaneously inputting the selected price and the number of holdings to a sell price blank and the number of sell input blank when the user selects a specific quotation on the profit and loss list window and transmitting a sell order to the securities server when an order transmission button is selected.

13. The cyber trading service method of claim 12, wherein, in (c), the CPU calculates and displays an advance-decline ratio (ADR), an advance-decline range, a profit and loss range, a commission, a total sell amount of money, a total sell ratio, a total profit and loss, a commission, a commission ratio, a net profit and loss, a net profit and loss ratio, and an entire profit and loss, according to the selection of the user.

14. The cyber trading service method of claim 13, wherein, in (c), the CPU calculates the stock price list using the basic price of the corresponding item; multiplies the number of holdings by each stock price on the stock price list, to thus calculate the total sell amount of money; multiplies the buy unit price by the number of holdings, to thus calculate the total buy amount of money; adds the buy commission to the sell commission, to thus calculate the commission; subtracts the total buy amount of money and the commission from the total sell amount of money, to thus calculate the net profit and loss of each stock price; and displays the total sell amount of money, the total buy amount of money, the commission, and the net profit and loss of each stock price when the user selects the net profit and loss list.

15. The cyber trading service method of claim 13, wherein, in (c), the CPU calculates the stock price list using the basic price of the corresponding item; divides each stock price on the stock price list by the basic price, to thus calculate the ADR; subtracts the basic price from each stock price, to thus calculate the advance-decline range; subtracts the buy price from the stock price, to thus calculate the profit and loss range; divides the stock price by the buy price, to thus calculate the yield; multiplies the stock price by the number of holdings, to thus calculate the total sell amount of money; divides the total sell amount of money by the total buy amount of money, to thus calculate the total sell ratio; subtracts the total buy amount of money from the total sell amount of money, to thus calculate the total profit and loss; multiplies the total buy amount of money and the total sell amount of money by the commission ratio, to thus calculate the commission; divides the commission by the trading amount of money (the total buy amount of money+the total sell amount of money), to thus calculate the commission ratio; subtracts the commission from the total profit and loss, to thus calculate the net profit and loss; divides the net profit and loss by the total buy amount of money, to thus calculate the net profit and loss ratio of each stock price on the stock price list; and displays the ADR, the advance-decline range, the profit and loss range, the total sell amount of money, the total sell ratio, the total profit and loss, the commission, the commission ratio, the net profit and loss, and the net profit and loss ratio when the user selects the entire profit and loss list.

16. The cyber trading service method of claim 15, wherein, in (c), a profit and loss value with respect to the quotation is updated at predetermined intervals and is displayed on the profit and loss list by quotation window when the quotation of the quotation information window changes.
